(19) United States
(12) Patent Application Publication
(10) Pub. No.: US 2026/0050733 A1
(43) Pub. Date: Feb. 19, 2026

(54) TASK LIST CREATION METHOD AND APPARATUS, AND DEVICE AND MEDIUM

(71) Applicant: Beijing Zitiao Network Technology Co., Ltd., Beijing (CN)

(72) Inventors: Danni Wu, Beijing (CN); Jingwen Guo, Beijing (CN); Yongning Fu, Beijing (CN); Zhaoxing Zhang, Beijing (CN)

(21) Appl. No.: 19/103,803

(22) PCT Filed: Dec. 12, 2023
(86) PCT No.: PCT/CN2023/138237

§ 371 Date: Feb. 13, 2025

(30) Foreign Application Priority Data
Dec. 16, 2022 (CN) 202211625212.X
Dec. 16, 2022 (CN) 202211625213.4
Dec. 16, 2022 (CN) 202211625719.5

(51) Int. Cl. G06F 40/166; G06F 21/62; G06Q 10/109; H04L 51/04

(52) U.S. Cl. CPC G06F 40/166; G06F 21/629; G06Q 10/1097; H04L 51/04

(57) ABSTRACT

Embodiments of the present disclosure disclose a task list creation method and apparatus, a device, and a medium. When a first user triggers a task list creation operation in a first client interface, task list related information entered by the first user is obtained. A first task list is generated based on the obtained task list related information, the first task list being a task container. Moreover, the first task list does not depend on another entity in an application to which the first client interface belongs, and may exist independently.

The present application claims priority to Chinese Patent Application No. 202211625719.5, filed with the China National Intellectual Property Administration on Dec. 16, 2022 and entitled “TASK LIST CREATION METHOD AND APPARATUS, DEVICE, AND MEDIUM”, to Chinese Patent Application No. 202211625212.X, filed with the China National Intellectual Property Administration on Dec. 16, 2022 and entitled “INFORMATION EXCHANGE METHOD AND APPARATUS, DEVICE, AND MEDIUM”, and to Chinese Patent Application No. 202211625213.4, filed with the China National Intellectual Property Administration on Dec. 16, 2022 and entitled “TASK LIST SHARING METHOD AND APPARATUS, DEVICE, AND MEDIUM”, which are incorporated herein by reference in their entireties.

### FIELD

The present disclosure relates to the field of computer technologies, and in particular, to a task list creation method and apparatus, a device, and a medium.

### BACKGROUND

In a collaboration scenario, a user often needs to receive and work on multiple tasks. In general, the multiple tasks are scattered and inconvenient to manage, resulting in low management efficiency and affecting the user experience.

### SUMMARY

To this end, embodiments of the present disclosure provide a task list creation method and apparatus, a device, and a medium, to manage multiple tasks through a task list, to improve the management efficiency and the user experience.

In order to achieve the above objective, the present disclosure provides the following technical solutions.

According to a first aspect of the present disclosure, there is provided a task list creation method. The method includes:
receiving a task list creation operation triggered by a first user in a first client interface, to obtain task list related information entered by the first user; and
generating a first task list based on the task list related information, where the first task list is a task container, and the first task list does not depend on another entity in an application to which the first client interface belongs.

According to a second aspect of the present disclosure, there is provided a task list creation apparatus. The apparatus includes:
a receiving unit configured to receive a task list creation operation triggered by a first user in a first client interface, to obtain task list related information entered by the first user; and
a generation unit configured to generate a first task list based on the task list related information, where the first task list is a task container, and the first task list does not depend on another entity in an application to which the first client interface belongs.

According to a third aspect of the present disclosure, there is provided an electronic device. The device includes a processor and a memory.

The memory is configured to store instructions or a computer program.

The processor is configured to execute the instructions or the computer program in the memory, to cause the electronic device to perform the method according to the first aspect.

According to a fourth aspect of the present disclosure, there is provided a computer-readable storage medium having instructions stored therein. The instructions, when run on a device, causes the device to perform the method according to the first aspect.

According to a fifth aspect of the present disclosure, there is provided a computer program product. The computer program product includes a computer program/instruction. The computer program/instruction, when executed by a processor, causes the method according to the first aspect to be implemented.

It can be learned that the present disclosure has the following beneficial effects.

In some embodiments of the present disclosure, when the first user triggers the task list creation operation in the first client interface, task list related information entered by the first user is obtained. The first task list is generated based on the obtained task list related information, and the first task list is the task container. Moreover, the first task list does not depend on the another entity in the application to which the first client interface belongs, and may exist independently. That is, according to the technical solutions provided in the present disclosure, scattered tasks may be managed by creating a task list, and the task list may exist independently, so that it is convenient for a user to operate the task list, and the flexibility of operation is improved.

### BRIEF DESCRIPTION OF THE DRAWINGS

To describe the technical solutions in the embodiments of the present disclosure or in the prior art more clearly, the accompanying drawings for describing the embodiments or the prior art will be briefly described below. Apparently, the accompanying drawings described below show merely some of the embodiments recited in the present disclosure, and those of ordinary skill in the art may still derive other accompanying drawings from these accompanying drawings without creative efforts.

FIG. 1 is a flowchart of a task list creation method according to an embodiment of the present disclosure;

FIG. 2a is a schematic diagram of creating a task list in a task center interface according to an embodiment of the present disclosure;

FIG. 2b is a schematic diagram of a create page according to an embodiment of the present disclosure;

FIG. 2c is a schematic diagram of display of a task list in a task center interface according to an embodiment of the present disclosure;

FIG. 3a is a schematic diagram of creating a task in a task list according to an embodiment of the present disclosure;

FIG. 3b is a schematic diagram of deleting a task list according to an embodiment of the present disclosure;

FIG. 4 is a schematic diagram of a structure of a task list creation apparatus according to an embodiment of the present disclosure;

FIG. 5 is a flowchart of an information exchange method according to an embodiment of the present disclosure;

FIG. 6a is a schematic diagram of adding a first chat tab according to an embodiment of the present disclosure;

FIG. 6b is a schematic diagram of display of a first interface according to an embodiment of the present disclosure;

FIG. 7a is a schematic diagram of a display position of a first chat tab according to an embodiment of the present disclosure;

FIG. 7b is a schematic diagram of display of a task list in a first chat according to an embodiment of the present disclosure;

FIG. 7c is a schematic diagram of a trigger operation for a first chat tab according to an embodiment of the present disclosure;

FIG. 8 is a schematic diagram of a structure of an information exchange apparatus according to an embodiment of the present disclosure;

FIG. 9 is a flowchart of a task list sharing method according to an embodiment of the present disclosure;

FIG. 10a is a schematic diagram of triggering sharing according to an embodiment of the present disclosure;

FIG. 10b is a schematic diagram of editing access permission of a second user according to an embodiment of the present disclosure;

FIG. 10c is another schematic diagram of editing access permission of a second user according to an embodiment of the present disclosure;

FIG. 11a is a schematic diagram of display of a preview card of a task list in a chat according to an embodiment of the present disclosure;

FIG. 11b is a schematic diagram of a preview card corresponding to a blank task list according to an embodiment of the present disclosure;

FIG. 11c is a schematic diagram of a preview card after deletion of a task list according to an embodiment of the present disclosure;

FIG. 11d is a schematic diagram of a preview card corresponding to no access permission according to an embodiment of the present disclosure;

FIG. 12a is a schematic diagram of an access permission request interface according to an embodiment of the present disclosure;

FIG. 12b is a schematic diagram of a notification message sent to an owner according to an embodiment of the present disclosure;

FIG. 12c is a schematic diagram of a notification message sent to a requester according to an embodiment of the present disclosure;

FIG. 12d is another schematic diagram of display of a preview card of a task list in a chat according to an embodiment of the present disclosure;

FIG. 13 is a schematic diagram of a structure of a task list sharing apparatus according to an embodiment of the present disclosure; and

FIG. 14 is schematic diagram of a structure of an electronic device according to an embodiment of the present disclosure.

### DETAILED DESCRIPTION OF EMBODIMENTS

In order for those skilled in the art to better understand the solutions of the present disclosure, the technical solutions in the embodiments of the present disclosure will be described below clearly and completely with reference to the accompanying drawings in the embodiments of the present disclosure. Apparently, the embodiments described are merely some rather than all of the embodiments of the present disclosure. All other embodiments obtained by those of ordinary skill in the art based on some embodiments of the present disclosure without any creative efforts shall fall within the scope of protection of the present disclosure.

To facilitate an understanding of the technical solutions provided by the embodiments of the present disclosure, description is given below with reference to the accompanying drawings.

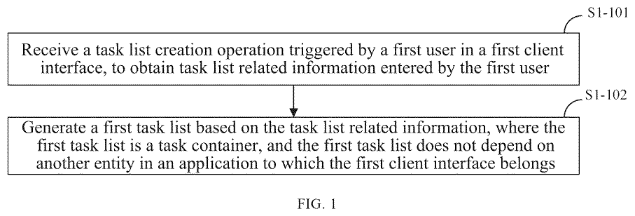

Reference is made to FIG. 1, which is a flowchart of a task list creation method according to an embodiment of the present disclosure. The method may be performed by a first client that may be installed in an electronic device. The electronic device may include a device with a communication function, for example, a mobile phone, a tablet computer, a notebook computer, a desktop computer, a vehicle-mounted terminal, a wearable electronic device, an all-in-one machine, and a smart home device, or may be a device simulated by a virtual machine or a simulator. As shown in FIG. 1, the method may include the following steps.

S1-101: a task list creation operation triggered by a first user in a first client interface is received, to obtain task list related information entered by the first user.

In some embodiments of the present disclosure, to create a task list, the first user may trigger the task list creation operation in the first client interface. When receiving the task list creation operation triggered by the first user, the first client obtains the task list related information entered by the first user. The task list related information may include a title of the task list, collaborators corresponding to the task list, permission of each collaborator on the task list, and the like.

The first client is a client of an application having a task list creation function, and the first client interface is a client interface of the application. For example, the first client interface is a task center interface, an instant messaging chat interface, a collaborative space interface, a cloud document interface, or the like. That is, the first user may trigger the task list creation operation in any of the above interfaces. Specifically, the first client may be a client of a standalone application or a client of an application in a collaborative office suite application. The collaborative office suite application usually integrates an instant messaging application and one or more of applications such as calendar, tasks, cloud documents, or audio or video conferences.

Receiving a task list creation operation triggered by a first user in a first client interface, to obtain task list related information entered by the first user may include: displaying a create page in response to the task list creation operation triggered by the first user in the first client interface; and obtaining the task list related information in response to an input operation triggered by the first user on the create page. The create page may include a task list title input box and a member adding control. The member adding control is an optional control. If the first user does not trigger the member adding control, a member is not added for the time being and will be added after the task list is created.

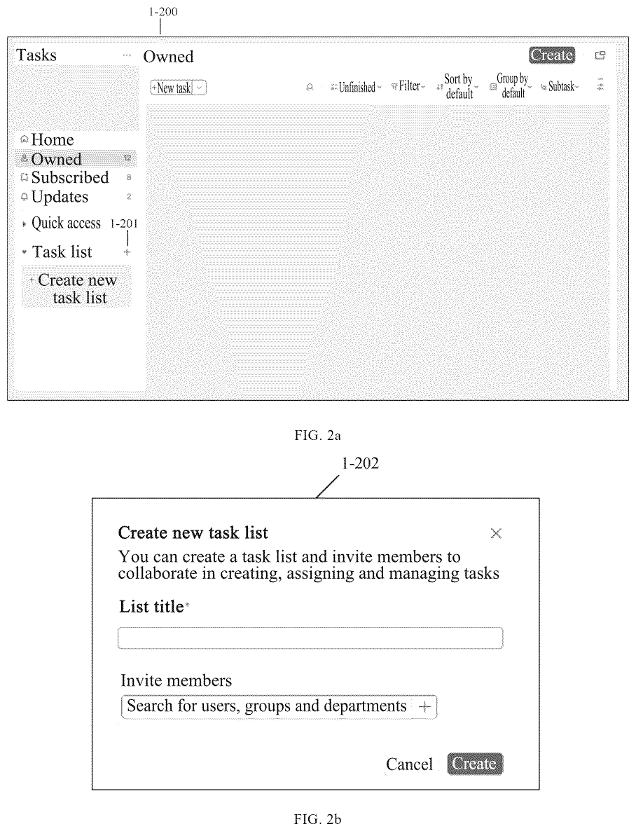

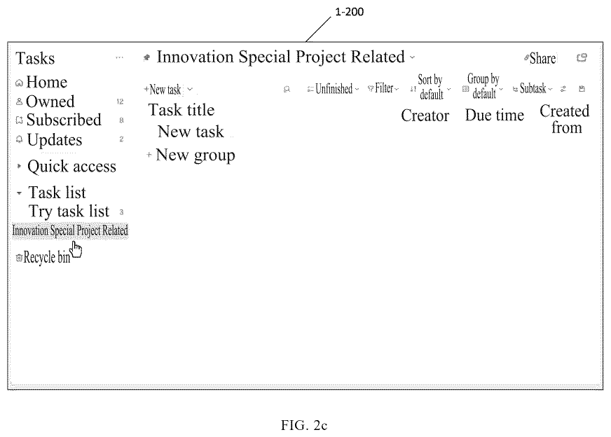

For example, as shown in FIG. 2a, when the first client interface is the task center interface, a task list creation control 1-201 may be displayed in a left area of a task center interface 1-200. When a user triggers the control 1-201, a create page 1-202 is displayed, as shown in FIG. 2b. The create page 1-202 includes a task list title input box and an invite member control. The user enters a title in the task list title input box, and may choose whether to invite a member via the invite member control as needed. When the user enters the title in the task list title input box, if the entered title exceeds a preset number of characters, the user may be prompted that an upper character limit has been reached.

After the user invites the member via the invite member control, the invited member may have first permission on the created task list by default. Alternatively, permission of the invited member is set. Specifically, invited members may be set as a whole, that is, all the invited members have the same permission; or permission of the invited members may be set separately.

S102: a first task list based on the task list related information is generated.

After the task list information is obtained, the first task list is generated based on the task list related information. The first task list is a task container for containing tasks. The first task list may include one or more tasks. In some embodiments, the task list may include zero tasks. In some embodiments of the present disclosure, a task may be created in the task list, or an existing task may be added to the task list. The tasks in the task list may be managed and operated based on the task list. In the embodiment of the present disclosure, the first task list does not depend on another entity in the application to which the first client interface belongs, and may exist independently. For example, in some embodiments of the present disclosure, the task list does not depend on entities such as a group, a team, a document, a conference, a collaborative space, a department, and a project. The application to which the first client interface belongs may be an application for collaborative office, such as an application focusing on an IM function, an application focusing on a task function, or an office suite application that integrates IM, tasks, documents, and other functions.

The application to which the first client interface belongs may be an independent IM application, an independent task application, or a collaborative office suite application that integrates multiple applications. The other entity refers to an entity created or defined in the application. For example, the other entity may be a chat group, a team, a collaborative space, or the like created in the application.

After being created, the first task list may be displayed in the first client interface. For example, as shown in FIG. 2c, after a creation operation for the first task list (named “Innovation Special Project Related”) is completed in the task center interface, a task list named “Innovation Special Project Related” may be displayed in the left area of the task center interface 1-200. When the user triggers the “Innovation Special Project Related” displayed in the left area, information about the task list, such as information about each task included in the task list, is displayed in a right area.

Thus, when the first user triggers the task list creation operation in the first client interface, the task list related information entered by the first user is obtained. The first task list is generated based on the obtained task list related information. The first task list is the task container for managing tasks. Moreover, the first task list does not depend on the another entity in the application to which the first client interface belongs, and may exist independently. That is, according to the technical solution provided in the present disclosure, scattered tasks may be managed by creating a task list, and the task list may exist independently, so that it is convenient for the user to operate the task list, and the flexibility of operation is improved.

When the first task list is created, different roles may be configured for the first task list, and different roles have different permission on the first task list. For example, the role in the first task list is classified into two types: an owner and a member. The owner of the first task list has edit permission on the first task list, and the member of the first task list has edit permission or read permission on the first task list. Although both the owner and the member each have the edit permission on the first task list, but the edit permission of the owner is different from that of the member.

The edit permission of the owner may include editing configuration information corresponding to the first task list and editing the task included in the first task list. The editing configuration information corresponding to the first task list includes editing the title and the member of the first task list, archiving the first task list, deleting the first task list, and the like.

The edit permission of the member means that the member can not only read the first task list, but also edit the configuration information of the first task list and edit the task included in the first task list. The editing configuration information corresponding to the first task list may include editing the title of the first task list, the member corresponding to the first task list, and the like, but does not include archiving the first task list or deleting the first task list. The read permission of the member means that the member can only read and/or comment on the first task list and read and/or comment on the task included in the first task list, but cannot edit the configuration information of the first task list, cannot create or add a task in the first task list, and cannot edit the task included in the first task list. The edit permission includes the read permission.

The first user is a creator of the first task list, that is, the owner, and edit permission of the first user on the first task list includes editing the task included in the first task list and the configuration information corresponding to the first task list. The editing the configuration information of the first task list includes archiving the first task list and deleting the first task list.

In some implementations, the owner of the task list can perform ownership transfer, so as to transfer ownership of the task list to another user. Specifically, the ownership of the first task list is transferred to a second user in response to a transfer operation triggered by the first user for the first task list, to make the second user the owner of the first task list. Specifically, a transfer control may be displayed in an interface corresponding to the first task list, and a transfer interface is displayed in response to a trigger operation of the first user for the transfer control. The first user may enter or search for, in the transfer interface, the second user to whom the first task list is to be transferred. After finding the second user, the first task list is transferred to the second user in response to a confirmation operation triggered by the first user in the transfer interface, to make the second user the owner of the first task list and have the permission of the owner. After the transfer is completed, the first user may be an ordinary member of the first task list, or may directly quit the first task list after the transfer.

The first task list may have one or more members, and the one or more members may be added in the following ways.

In one way, when the first task list is created, the task list related information entered by the first user includes member information, and when the first task list is generated based on the task list related information, the member is added to the first task list based on the member information. That is, when the first task list is created, the corresponding member information is added, so that when the first task list is generated, the member is added to the first task list.

In one way, after the first task list is generated, the member is added to the first task list in response to a member adding operation triggered for the first task list. A user who triggers the member adding operation may be the owner of the first task list or the member having the edit permission on the first task list, which is not limited in this embodiment.

In one way, if the first task list is created in an instant messaging chat interface, all or some of members of an instant messaging chat are determined as members of the first task list. That is, if the first task list is created in the instant messaging chat interface, when the first task list is created, all or some of the members in the instant messaging chat may be determined as the members of the first task list. Specifically, when the first task list is created, all the members of the instant messaging chat may be selected with one click, or a chat member to be added may be separately selected through a check box corresponding to the chat member.

In one way, if the first task list is created in a cloud document interface, all or some of collaborators of the cloud document interface are determined as members of the first task list. That is, if the first task list is created in the cloud document interface, when the first task list is created, all or some of the collaborators of the cloud document interface may be determined as the members of the first task list. Specifically, when the first task list is created, all the members of the cloud document interface may be selected with one click, or a chat member to be added may be separately selected through a check box corresponding to the collaborator.

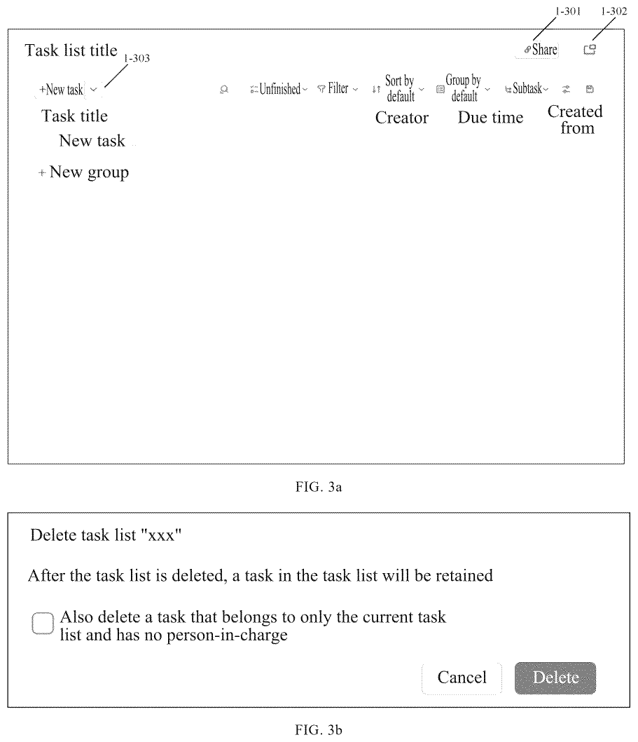

After the first task list is created, a task may be created or added in the first task list, so as to manage the task through the first task list. In a schematic diagram of the interface corresponding to the first task list shown in FIG. 3a, the title of the first task list, a share control 1-301, an independent window 1-302, and a task control 1-303 may be displayed. Sharing of the first task list may be triggered through the share control 1-301. Display of the first task list through an independent window may be triggered through the independent window 1-302. A task may be created or added in the first task list through the task control 1-303. A task adding button may be displayed through a drop-down menu in the task control 1-303. In addition, other operations for tasks, such as filtering, sorting, and subtask adding, may also be displayed in the interface as shown in FIG. 3a.

In some implementations, in response to creating or adding a target task in the first task list, permission on the first task list is configured for the member of the first task list based on permission of the member of the first task list on the first task list. That is, when the target task is created or added in the first task list, the permission of the member of the first task list on the target task is configured based on the permission of the member of the first task list on the first task list. For example, when a member of the first task list has edit permission on the first task list, and the edit permission includes edit permission on the task in the first task list, the member has edit permission on the target task as well. When a member of the first task list has read permission on the first task list, the member has at least read permission on the target task. The reason for having at least the read permission here is that if the member originally has higher permission on the target task, the original higher permission is retained. For example, user A is a member of the first task list and has read permission on the first task list, and user A is originally a collaborator of the target task and has edit permission on the target task. In this case, user A still has edit permission on the target task added to the first task list. One task may be added to multiple different task lists.

In some implementations, the following operations may be further performed.

One operation is stopping displaying, in response to a task in the first task list being deleted, the deleted task in the first task list.

One operation is skipping performing a delete operation on a task in the first task list in response to the first task list being deleted. That is, the task list is deleted, and the task in the task list is not deleted by default.

One operation is deleting a task without a person-in-charge in the first task list in response to the first task list being deleted. That is, when the task list is deleted, a task without a person-in-charge in the task list may be deleted. Specifically, when the task list is deleted, the user may choose whether to delete the task without the person-in-charge in the task list, and if the user chooses to delete the task, the task without the person-in-charge is deleted. For example, as shown in FIG. 3b, when the user triggers deletion of a task list, a prompt box may be displayed, and a check box is displayed in the prompt box, so that the user can choose whether to delete a task without a person-in-charge in the task list.

In some implementations, if the first task list is created or added in a first service interface, first permission on the first task list is granted to an associated member of the first service interface by default; and permission of the associated member on the first task list is changed to second permission in response to an edit operation triggered for the first task list. That is, when the user creates or adds the first task list in the first service interface, the first permission on the first task list may be granted in advance to the associated member of the first service interface by default. A permission change operation may be triggered during the creation or addition process, to change the permission of the associated member on the first task list to the second permission. Alternatively, a permission change operation is triggered after the creation or addition is completed, to change the permission of the associated member on the first task list to the second permission.

In some implementations, if the first task list is created or added in a first service interface, permission on the first task list is granted to an associated member of the first service interface based on a permission configuration operation. That is, when the first task list is created or added in the first service interface, the user may configure permission for the associated member of the first service interface. Specifically, during permission configuration, unified permission configuration may be performed for all associated members of the first service interface, or different permission may be configured for different associated members based on a member granularity.

Each piece of the first permission and the second permission is one of no access permission, read permission, or edit permission. The first service interface may include an instant messaging chat interface or a cloud document interface. When the first service interface is the instant messaging chat interface, the associated member of the first service interface is some or all of corresponding chat members. When the first service interface is the cloud document chat interface, the associated member of the first service interface is some or all of corresponding cloud document collaborators.

In some implementations, if permission of one or more associated members on the first task list is changed to no permission, first prompt information is displayed in the first service interface corresponding to the one or more associated members, where the first prompt information is used to prompt for no permission to access the first task list. That is, when permission of an associated member on the first task list is changed from access permission to no access permission, the associated member can still see the first task list in the first service interface, but cannot view related content of the first task list, and can see only the first prompt information.

The first prompt information may be presented in various ways. In one way, the first task list is displayed in a preset mode, to prompt in the preset mode that the user has no access permission, for example, its color is set to gray. In one way, the first prompt information is displayed when a mouse hovers over the first task list. In one way, the first prompt information is displayed when the associated member clicks on the first task list.

To help an associated member request the access permission, an access permission request control may be displayed, and a request page may be displayed in response to a trigger operation of the associated member for the access permission request control. The owner of the first task list may be displayed on the request page, and the associated member triggers a send control in the request page, to request the access permission from the owner.

Second prompt information is displayed in the first service interface if the first task list is deleted, where the second prompt information is used to prompt that the first task list has been deleted. That is, after the first task list is deleted, the second prompt information may be displayed in the first service interface to prompt the associated member of the first service interface that the first task list has been deleted. For a presentation form of the second prompt information, refer to the related descriptions of the first prompt information.

As shown in FIG. 3a, a share operation may be further triggered for the first task list. Specifically, in response to a third user sharing the first task list with a fourth user, permission on the first task list is granted to the fourth user. The permission of the fourth user on the first task list is not higher than that of the third user on the first task list. That is, a user can only spread highest permission of the user on the first task list. The third user may be the owner of the first task list or a member of the first task list. Specifically, user A shares a task list with user B. If user A has only read permission on the task list, user B can obtain only read permission on the task list through the share operation of user A; and if user A has edit permission on the task list, when sharing the task list with user B, user A may grant edit permission to user B, or grant only read permission to user B.

In some implementations, if the first task list includes a first member and a first task, permission of the first member on the first task is target permission, and the target permission is the higher permission from permission corresponding to a role that the first member takes in the first task and permission on the first task list granted to the first member. That is, permission of a user on a task is equal to the larger value of {permission granted to a task role, permission granted in a task list}.

For example, user A has edit permission on task list 1 (including edit permission on a task in task list 1), and user A is also a follower of task 1. A follower of a task has only read permission but no edit permission. When task 1 is added to task list 1, user A can edit task 1 because user A has the edit permission on the list. For another example, user A is a person in charge of task 2 and can edit the task, and user B adds task 2 to task list 2, but grants only read permission to user A. In this case, user A can edit task 2 because user A is the person in charge of task 2 and has edit permission.

Based on the above method embodiment, an embodiment of the present disclosure provides a task list creation apparatus and an electronic device, which will be described below with reference to the accompanying drawings.

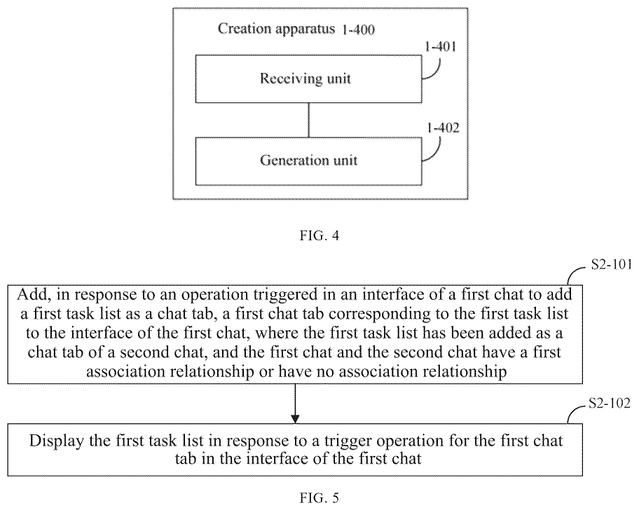

Reference is made to FIG. 4, which is a schematic diagram of a structure of a task list creation apparatus according to an embodiment of the present disclosure. As shown in FIG. 4, the apparatus 1-400 includes a receiving unit 1-401 and a generation unit 1-402.

The receiving unit 1-401 is configured to receive a task list creation operation triggered by a first user in a first client interface, to obtain task list related information entered by the first user.

The generation unit 1-402 is configured to generate a first task list based on the task list related information. The first task list is a task container. The first task list does not depend on another entity in an application to which the first client interface belongs.

In some implementations, the first client interface is a task center interface, an instant messaging chat interface, a collaborative space interface, or a cloud document interface.

In some implementations, the first user is an owner of the first task list, and the owner of the first task list has edit permission for the first task list.

In some implementations, the apparatus further includes a transfer unit.

The transfer unit is configured to transfer ownership of the first task list to a second user in response to a transfer operation triggered by the first user for the first task list, to make the second user the owner of the first task list.

In some implementations, the edit permission includes one or more of:
editing configuration information corresponding to the first task list, where the editing configuration information corresponding to the first task list includes archiving the first task list and/or deleting the first task list; or
editing a task included in the first task list.

In some implementations, the first task list has one or more members, and the members each have edit permission or read permission on the first task list.

In some implementations, the member of the first task list is added in one or more of the following ways:
the task list related information includes member information, and when the first task list is generated based on the task list related information, a member is added to the first task list based on the member information;
after the first task list is generated, the member is added to the first task list in response to a member adding operation triggered for the first task list;
if the first task list is created in an instant messaging chat interface, all or some of chat members of the instant messaging chat are determined as members of the first task list; or
if the first task list is created in a cloud document interface, all or some of collaborators of the cloud document interface are determined as members of the first task list.

In some implementations, the edit permission of the member includes one or more of:
editing configuration information corresponding to the first task list, where the editing configuration information corresponding to the first task list does not include archiving the first task list or deleting the first task list; or
editing a task included in the first task list.

In some implementations, the read permission includes one or more of:
reading and/or commenting on the first task list, without permission to edit configuration information corresponding to the first task list; or
reading and/or commenting on a task included in the first task list, without permission to create or add a task in the first task list and without permission to edit the task included in the first task list.

In some implementations, the apparatus further includes a configuration unit.

The configuration unit is configured to configure, in response to creating or adding a target task in the first task list, permission on the target task for a member of the first task list based on permission of the member of the first task list on the first task list.

In some implementations, if one member of the first task list has edit permission for the first task list, the member has edit permission for the target task; and if a member of the first task list has read permission on the first task list, the member has at least read permission on the target task.

In some implementations, the apparatus further includes a processing unit.

The processing unit is configured to stop displaying, in response to a task in the first task list being deleted, the deleted task in the first task list.

The processing unit is further configured to skip, in response to the first task list being deleted, performing a delete operation on a task in the first task list.

The processing unit is configured to delete, in response to the first task list being deleted, a task without a person-in-charge in the first task list.

In some implementations, the apparatus further includes a configuration unit and a change unit.

The configuration unit is configured to: if the first task list is created or added in a first service interface, grant first permission on the first task list to an associated member of the first service interface by default, and
the change unit is configured to change permission of the associated member on the first task list to second permission in response to an edit operation triggered for the first task list; or
the configuration unit is further configured to: if the first task list is created or added in a first service interface, grant permission on the first task list to an associated member of the first service interface based on a permission configuration operation.

In some implementations, the first service interface includes an instant messaging chat interface or a cloud document interface.

When the first service interface is the instant messaging chat interface, the associated member of the first service interface is some or all of corresponding chat members.

When the first service interface is the cloud document chat interface, the associated member of the first service interface is some or all of corresponding cloud document collaborators.

In some implementations, the apparatus further includes a display unit.

The display unit is configured to: if permission of one or more associated members on the first task list is changed to no permission, display first prompt information in the first service interface corresponding to the one or more associated members, where the first prompt information is used to prompt for no permission to access the first task list.

The display unit is further configured to display second prompt information in the first service interface if the first task list is deleted, where the second prompt information is used to prompt that the first task list has been deleted.

In some implementations, the apparatus further includes a configuration unit.

The configuration unit is configured to: in response to a third user sharing the first task list with a fourth user, grant permission on the first task list to the fourth user, where the permission of the fourth user on the first task list is not higher than that of the third user on the first task list.

In some implementations, if the first task list includes a first member and a first task, permission of the first member on the first task is target permission, and the target permission is a higher on of permission corresponding to a role that the first member takes in the first task and permission on the first task list granted to the first member.

It should be noted that, for a specific implementation of the various units in this embodiment, reference may be made to the related description in the above method embodiment. The division into the units in this embodiment of the present disclosure is illustrative and is merely logical function division, and there may be other division methods in actual implementation. Various function units in this embodiment of the present disclosure may be integrated into one processing unit, each of the units may exist alone physically, or two or more units may be integrated into one unit. For example, in the above embodiment, a processing unit and a sending unit may be the same unit or different units. The integrated unit may be implemented in the form of hardware, or may be implemented in the form of a software function unit.

In a collaboration scenario, a user often needs to receive and work on multiple tasks. In general, the multiple tasks are scattered, resulting in low management efficiency and affecting the user experience. How to help the user manage tasks is a technical problem that needs to be solved urgently.

To facilitate task management, tasks are managed by creating a task list, but the user obtains the task list in a complicated way, which affects the user experience. To help the user view a same task list in different chats, an embodiment of the present disclosure further provides an information exchange method, in which the user may add the same task list as chat tabs to different chats, and multiple different chats may be chats having a first association relationship or having no association relationship, so that the user can view the task list conveniently.

To facilitate an understanding of the technical solutions provided by the embodiments of the present disclosure, description is given below with reference to the accompanying drawings.

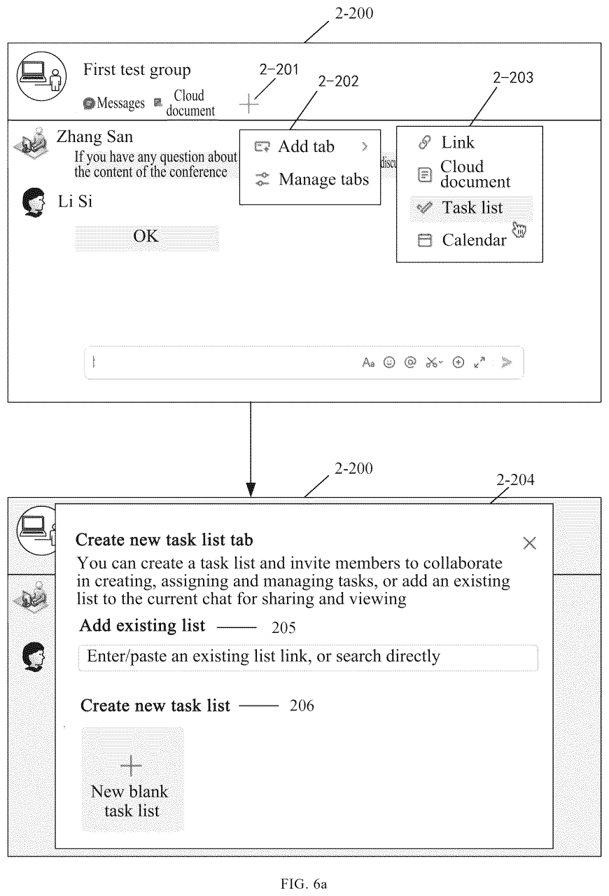

Reference is made to FIG. 5, which is a flowchart of an information exchange method according to an embodiment of the present disclosure. As shown in FIG. 5, the method may be performed by an instant messaging client that may be installed in an electronic device. The electronic device may include a device with a communication function, for example, a mobile phone, a tablet computer, a notebook computer, a desktop computer, a vehicle-mounted terminal, a wearable electronic device, an all-in-one machine, and a smart home device, or may be a device simulated by a virtual machine or a simulator. As shown in FIG. 1, the method may include the following steps.

S2-101: in response to an operation triggered in an interface of a first chat to add a first task list as a chat tab, a first chat tab corresponding to the first task list is added to the interface of the first chat.

In this embodiment, a user may trigger the operation in the interface of the first chat to add the first task list as the chat tab. After receiving the above operation, the instant messaging client adds the first chat tab corresponding to the first task list to the interface of the first chat. The first task list has been added as a chat tab of a second chat, the chat tab corresponding to the first task list in an interface of the second chat is a second chat tab, and the first chat and the second chat have no association relationship, or the first chat and the second chat have a first association relationship. That is, the user may not only add the same task list as chat tabs to multiple chats having the first association relationship, but also add the same task list to multiple chats having no association relationship.

In some embodiments of the present disclosure, that the first chat and the second chat have no association relationship may mean that there is no subordinate relationship between the first chat and the second chat, and the first chat and the second chat do not belong to the same other entity (such as a group, a team, a workspace, a department, or a project). For example, the first chat and the second chat are not chats within the same team or workspace. Thus, in these embodiments, a task list can be flexibly and freely added to a chat tag of any chat.

In some embodiments of the present disclosure, that the first chat and the second chat have the first association relationship may mean that the first chat and the second chat belong to the same other entity (such as a group, a team, a workspace, a department, or a project).

The first chat tab and the second chat tab may have the same tag name or different tag names. For example, when a title of the first task list is used as a tag name of the chat tab, the first chat tab and the second chat tab have the same tag name. Alternatively, when the first task list is added as the chat tab, the name of the chat tab may be re-edited. In this case, the first chat tab and the second chat tag may have different tag names.

When addition of the first task list as the chat tab is triggered in the interface of the first chat, the first task list may be an existing task list or a task list newly created when the chat tab is added. The above different cases will be described below.

If the first task list does not exist before the first chat tab corresponding to the first task list is added to the interface of the first chat, a first interface is displayed in response to a trigger operation for a first add control in the interface of the first chat, where the first interface is used to add a chat tab corresponding to a task list. The first task list is created in response to a task list creation operation triggered in the first interface, and the first chat tab corresponding to the first task list is added to the interface of the first chat.

In this embodiment, if the first task list does not exist before the first chat tab is added to the interface of the first chat, the user may trigger the first add control in the interface of the first chat, the first add control being used to trigger display of the first interface that is used to add a chat tab corresponding to a task list. When the user triggers the task list creation operation in the first page, the first task list is created, and the first chat tab corresponding to the first task list is added to the interface of the first chat.

If the first task list already exists before the first task list tag is added to the interface of the first chat, a first interface is displayed in response to a trigger operation for a first add control in the interface of the first chat, where the first interface is used to add a chat tab corresponding to a task list. In response to an operation triggered in the first interface to add the existing first task list, the first chat tab corresponding to the first task list is added to the interface of the first chat.

In this embodiment, if the first task list already exists before the first chat tab is added to the interface of the first chat, the first interface is displayed in response to the trigger operation of the user for the first add control in the interface of the first chat. After the user triggers the operation in the first interface to add the existing first task list, the first chat tab is added to the interface of the first chat.

Displaying the first interface in response to the trigger operation for the first add control in the interface of the first chat may include the following process: displaying a first window in response to a trigger operation for a first control in the interface of the first chat, where the first window includes a tab adding control; displaying a second window in response to a trigger operation for the tab adding control, where the second window includes a task list tab adding control; displaying a second window in response to a trigger operation for the tab adding control, where the second window includes a task list tab adding control; and displaying the first interface in response to a trigger operation for the task list tab adding control.

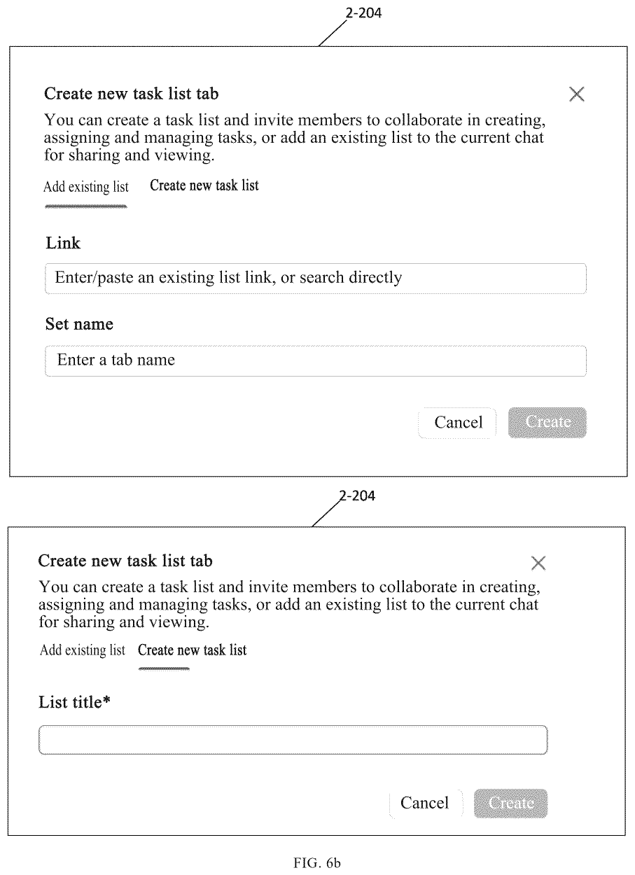

Specifically, in an application scenario as shown in FIG. 6a, a first window 2-202 is displayed in response to a trigger operation of the user for a first control 2-201 in an interface 2-200 of the first chat, the first window 2-202 including an “Add tab” control and “Manage tabs”. A second window 2-203 is displayed in response to a trigger operation of the user for the “Add tab” control, where the second window 2-203 includes a “Link” control, a “Cloud document” control, a “Task list” control (a task list tab adding control), and a “Calendar” control. A first interface 2-204 is displayed in response to a trigger operation of the user for the “Task list” control. The first interface 2-204 may include an “Add existing task list” control 2-205 and a “Create new task list” control 2-206. The user may choose to trigger the “Add existing task list” control 2-205 or the “Create new task list” control 2-206 according to own needs.

The “Add existing task list” control and the “Create new task list” control in the first interface 2-204 may alternatively be displayed horizontally in the interface, as shown in FIG. 6b, and the user may switch to display interfaces corresponding to different controls in the first interface 2-204.

Specifically, when the user triggers the “Add existing task list” control, an operation interface corresponding to the control is displayed, and the user may search, in the operation interface by entering/pasting a link to an existing task list to be added or directly, for the existing task list to be added. In addition, the user may further enter the tag name of the first chat tab in the operation page. Setting a tag name may be set as optional, and if the user does not enter the tag name, a title of a found task list is used as the tag name of the first chat tab. After completing the operation in the operation interface, the user clicks on an add control in the first interface 2-204 to add the first chat tab to the interface 2-200 of the first chat. When searching for a task list, the user can find a task list on which the user has access permission, but cannot search for a task list on which the user does not have access permission. The access permission may include edit permission and read permission. That is, the user can add the task list on which the user has the access permission as a chat tab to an interface of a chat.

After the user triggers the “Create new task list” control, an operation interface corresponding to the control is displayed, and the user may enter a title of a task list to be created in the operation interface. After the title is entered, the first task list is created in response to a trigger operation of the user for the creation control, and in addition, the first chat tab is added to the interface 2-200 of the first chat. In this case, the tag name of the first chat tab may be the title of the first task list. Alternatively, the operation interface may further include an input box that is used for the user to define the tag name of the first chat tab.

The interface of the first chat includes a chat message display area and a non-chat message display area. The first chat tab is displayed in a first display area of the non-chat message display area. A second display area of the non-chat message display area is used to display basic information and/or a basic function menu of the first chat. The basic information may include an avatar of the first chat, a chat name, the number of members included in the chat, and the like.

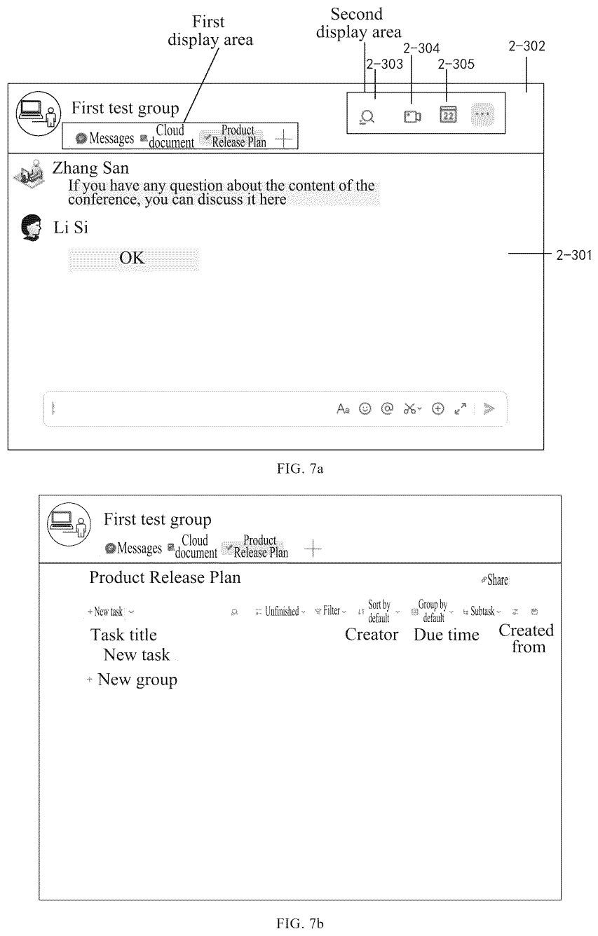

For example, as shown in FIG. 7a, the interface of the first chat includes a chat message display area 2-301 and a non-chat message display area 2-302. The non-chat message display area 2-302 includes a first display area 2-3021 and a second display area 2-3022 (part of the second display area). An added chat tab, such as a message tab and a task list tab “Product Release Plan”, may be displayed in the first display area 2-3021. The basic function menu of the chat is displayed in the second display area 2-3022. The basic function menu may include a search control 2-303, a multimedia control 2-304, and a calendar control 2-305. The multimedia control can implement a video call and an audio call. It should be noted that FIG. 7a is only an example for ease of understanding, and the second display area is a remaining display area of the non-chat message display area other than the first display area.

When the first chat tab is displayed in the interface of the first chat, a preset identifier corresponding to a task type may also be displayed, so that the user can quickly identify, by using the preset identifier, that the chat tab is the tab of the task list. As shown in FIG. 7a, when a task list tab “Product Release Plan” is displayed, a corresponding preset identifier is displayed.

S2-102: a first task list is displayed in response to a trigger operation for the first chat tab in the interface of the first chat.

In this embodiment, After the instant messaging client receives the trigger operation of the user for the first chat tab in the interface of the first chat, the first task list is displayed, so that the user can view related information of the first task list.

A task list is a task container, and may include one or more tasks. In some embodiments, a task may be created in the task list, an existing task may also be added to the task list, and each task in the task list may be managed and operated based on the task list. In some embodiments, the task list does not depend on another entity in the client, and may exist independently. For example, the task list does not depend on entities such as a group, a team, a document, a conference, a collaborative space, a department, and a project. The client may be an application for collaborative office, such as an application focusing on an IM function, an application focusing on a task function, or a suite application that integrates IM, tasks, documents and other functions.

In specific implementation, the first task list may be displayed in the following manner, which is specifically displaying the first task list in the interface of the first chat in response to the trigger operation for the first chat tab in the interface of the first chat. That is, the related information of the first task list is displayed in the interface of the first chat. Specifically, the related information of the first task list is displayed in the chat message display area. Alternatively, the first task list is displayed in a third window in response to the trigger operation for the first chat tab in the interface of the first chat, where the third window is independent of the interface of the first chat. That is, after the user triggers the first chat tab, the related information of the first task list may be displayed in an independent window.

The related information of the first task list is as shown in FIG. 3b, and an included task, a creator and due time of each task, subtask(s) included in each parent task, and the like may be displayed.

In some implementations, a fourth window is displayed in response to triggering a preset operation for the first chat tab in the interface of the first chat. The fourth window may include one or more of the following controls: an open control used to open the task list in a task center; a copy control used to copy a link to the first task list; an edit control used to edit a tag name of the first chat tab; or a delete control used to remove the first chat tab from the interface of the first chat. The preset operation may be set according to an actual situation. For example, the preset operation is a double-click operation, a right-click operation, or the like.

For example, as shown in FIG. 7c, a fourth window 2-306 is displayed when the user selects the first chat tab and triggers a right-click operation. The fourth window 2-306 includes an “Open in task center” control, a “Copy link” control, an “Edit” control, and a “Delete” control.

In some implementations, first permission on the first task list is granted to all or some of members in the first chat in response to adding the first chat tab corresponding to the first task list to the interface of the first chat. That is, when the first chat tab is added to the interface of the first chat, all or some of the chat members in the first chat may be added as collaborators of the first task list, and then the first permission is assigned to the collaborators.

The first permission may be read permission or edit permission. The edit permission means that the member can not only read the first task list, but also edit configuration information of the first task list and edit a task included in the first task list. The editing configuration information corresponding to the first task list may include editing the title of the first task list, a member corresponding to the first task list, and the like, but does not include archiving the first task list or deleting the first task list. The read permission means that the member can only read and/or comment on the first task list and read and/or comment on the task included in the first task list, but cannot edit the configuration information of the first task list, cannot create or add a task in the first task list, and cannot edit the task included in the first task list. The edit permission includes the read permission.

The first permission may be default permission, or may be permission after the user edits default permission when adding a collaborator, which is not limited in this embodiment.

In some implementations, a permission editing control is provided before the first permission on the first task list is granted to the member in the first chat, to grant the first permission on the first task list to all or some of the members in the first chat based on an operation of the user on the permission editing control. That is, when the first chat tab is added to the interface of the first chat, the permission editing control may be provided for the user, so that when the first chat tab is added, the first permission on the first task list is granted to all or some of the members in the first chat.

In some implementations, after the first chat tab corresponding to the first task list is added to the interface of the first chat, permission of all or some of the members in the first chat on the first task list is changed to second permission in response to an edit operation triggered for the first chat tab. That is, after the first chat tab is added to the interface of the first chat, the permission of all or some of the members in the first chat on the first task list may be changed. For example, when the first chat tab is added, the permission granted to all or some of the members in the first chat on the first task list is read permission, and the permission of all or some of the members in the first chat on the first task list may be changed from the read permission to edit permission through the edit operation triggered for the first chat tab.

In some implementations, if the first chat tab is removed from the interface of the first chat, the following processing may be performed on the permission of all or some of the members in the first chat on the first task list.

In one processing, access permission of all or some of the members in the first chat on the first task list is retained if the first chat tab is removed from the interface of the first chat.

In one processing, access permission of all or some of the members in the first chat on the first task list is removed if the first chat tab is removed from the interface of the first chat.

If the first chat tab is removed from the interface of the first chat, read permission on the first task list is granted to all or some of the members in the first chat. This case mainly means that the permission of all or some of the members in the first chat on the first task list before removal of the first chat tab is the edit permission, and when the first chat tab is removed from the interface of the first chat, the permission of all or some of the members in the first chat on the first task list is changed to the read permission.

This embodiment of the present disclosure provides the information exchange method and apparatus, a device, and a medium, to implements addition of a task list to a tab of a chat, so that the user can quickly view the task list in the chat. Thus, according to the technical solutions provided by this embodiment of the present disclosure, the first chat tab corresponding to the first task list is added to the interface of the first chat when receiving the trigger operation triggered by the user in the interface of the first chat to add the first task list as the chat tab. The first task list has been added as the chat tab of the second chat, the chat tab corresponding to the first task list in the interface of the second chat is the second chat tab, and the first chat and the second chat may have atr first association relationship or have no association relationship. That is, the same task list may be added to tabs of multiple chats having the first association relationship or having no association relationship. The first task list is displayed in response to the trigger operation for the first chat tab in the interface of the first chat. The first task list may include one or more tasks. That is, according to this embodiment of the present disclosure, one task list may be added to tabs of multiple chats having the first association relationship or having no association relationship, so that the user can view the task list in different chats through the chat tabs, which improves the user experience.

Based on the above method embodiment, an embodiment of the present disclosure provides an information exchange apparatus and an electronic device, which will be described below with reference to the accompanying drawings.

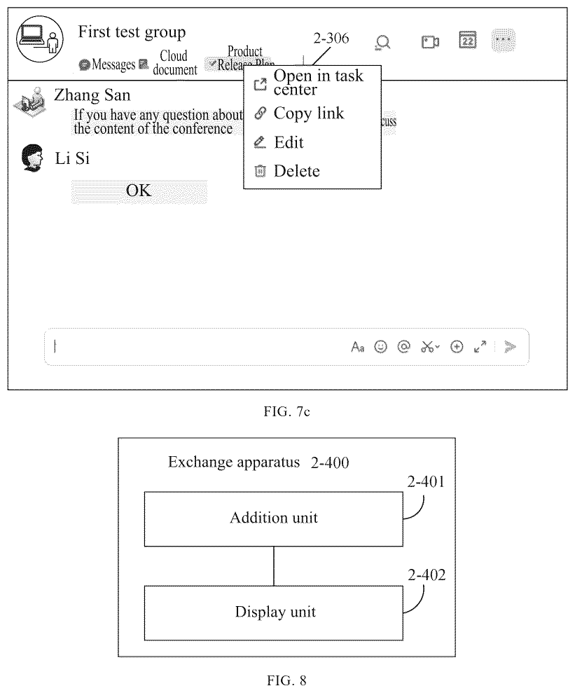

Reference is made to FIG. 8, which is a schematic diagram of a structure of an information exchange apparatus according to an embodiment of the present disclosure. As shown in FIG. 8, the apparatus 2-400 includes an addition unit 2-401 and a display unit 2-402.

The addition unit 2-401 is configured to add, in response to an operation triggered in an interface of a first chat to add a first task list as a chat tab, a first chat tab corresponding to the first task list to the interface of the first chat. The first task list has been added as a chat tab of a second chat. The chat tab corresponding to the first task list in an interface of the second chat is a second chat tab. The first chat and the second chat have a first association relationship or have no association relationship.

The display unit 2-402 is configured to display the first task list in response to a trigger operation for the first chat tab in the interface of the first chat.

In some implementations, the apparatus further includes a configuration unit.

The configuration unit is configured to grant first permission on the first task list to all or some of members in the first chat in response to adding the first chat tab corresponding to the first task list to the interface of the first chat.

In some implementations, the apparatus further includes a configuration unit and a change unit.

The configuration unit is configured to provide a permission editing control before the first permission on the first task list is granted to the member in the first chat, to grant the first permission on the first task list to all or some of the members in the first chat based on an operation of a user for the permission editing control.

The change unit is configured to: after the first chat tab corresponding to the first task list is added to the interface of the first chat, change permission of all or some of the members in the first chat on the first task list to second permission in response to an edit operation triggered for the first chat tab.

In some implementations, the interface of the first chat includes a chat message display area and a non-chat message display area, the first chat tab is displayed in a first display area of the non-chat message display area, and a second display area of the non-chat message display area is used to display basic information and/or a basic function control of the first chat.

In some implementations, the addition unit 2-401 is specifically configured to: if the first task list does not exist before the first chat tab corresponding to the first task list is added to the interface of the first chat, display a first interface in response to a trigger operation for a first add control in the interface of the first chat, where the first interface is used to add a chat tab corresponding to a task list, create the first task list in response to a task list creation operation triggered in the first interface, and add the first chat tab corresponding to the first task list to the interface of the first chat; or
the addition unit 2-401 is specifically configured to: if the first task list already exists before the first task list tag is added to the interface of the first chat, display a first interface in response to a trigger operation for a first add control in the interface of the first chat, the first interface being used to add a chat tab corresponding to a task list, and in response to an operation triggered in the first interface to add the existing first task list, add the first chat tab corresponding to the first task list to the interface of the first chat.

In some implementations, the addition unit 2-401 is specifically configured to: display a first window in response to a trigger operation for a first control in the interface of the first chat, where the first window includes a tab adding control; display a second window in response to a trigger operation for the tab adding control, where the second window includes a task list tab adding control; and display the first interface in response to a trigger operation for the task list tab adding control.

In some implementations, the display unit 2-402 is specifically configured to display the first task list in the interface of the first chat in response to the trigger operation for the first chat tab in the interface of the first chat; or
the display unit 2-402 is specifically configured to display the first task list in a third window in response to the trigger operation for the first chat tab in the interface of the first chat, the third window being independent of the interface of the first chat.

In some implementations, the display unit 2-402 is further configured to display a fourth window in response to triggering a preset operation for the first chat tab in the interface of the first chat.

The fourth window includes one or more of the following controls:
an open control used to open the task list in a task center;
a copy control used to copy a link to the first task list;
an edit control used to edit a tag name of the first chat tab; or
a delete control used to remove the first chat tab from the interface of the first chat.

In some implementations, a display style of the first chat tab includes a preset identifier corresponding to a task type.

In some implementations, the apparatus further includes a processing unit.

The processing unit is configured to retain access permission of all or some of the members in the first chat on the first task list if the first chat tab is removed from the interface of the first chat; or
the processing unit is configured to remove access permission of all or some of the members in the first chat on the first task list if the first chat tab is removed from the interface of the first chat; or
the processing unit is configured to: if all or some of the members in the first chat have edit permission on the first task list, grant read permission on the first task list to all or some of the members in the first chat after the first chat tab is removed from the interface of the first chat.

It should be noted that, for a specific implementation of the various units in this embodiment, reference may be made to the related description in the above method embodiment. The division into the units in this embodiment of the present disclosure is illustrative and is merely logical function division, and there may be other division methods in actual implementation. Various function units in this embodiment of the present disclosure may be integrated into one processing unit, each of the units may exist alone physically, or two or more units may be integrated into one unit. For example, in the above embodiment, a processing unit and a sending unit may be the same unit or different units. The integrated unit may be implemented in the form of hardware, or may be implemented in the form of a software function unit.

In a collaboration scenario, a user often needs to receive and work on multiple tasks. In general, the multiple tasks are scattered and inconvenient to manage, affecting the user experience. How to effectively manage tasks is a technical problem that needs to be solved urgently.

In the embodiments of the present disclosure, in order to facilitate task management, multiple tasks are managed by creating a task list. Considering that most of collaborations currently take place in chats or cloud documents, to facilitate collaboration, task lists may be shared, so that the task lists can be browsed in different collaboration scenarios, facilitating collaboration between users.

On this basis, an embodiment of the present disclosure further provides a task list sharing method. First, in response to a share operation triggered by a first user for a target task list, access permission of a second user corresponding to the share operation on the target task list is determined. After the access permission of the second user on the target task list is determined, preview data corresponding to the target task list is displayed in a display interface of the second user corresponding to the share operation based on the access permission, so that the second user can directly browse related information of the target task list through the display interface, which improves the user experience.

To facilitate an understanding of the technical solutions provided by the embodiments of the present disclosure, description is given below with reference to the accompanying drawings.

Reference is made to FIG. 9, which is a flowchart of a task list sharing method according to an embodiment of the present disclosure. The method may be performed by a client that may have a task list creation and/or a sharing function and is installed in an electronic device. The electronic device may include a device with a communication function, for example, a mobile phone, a tablet computer, a notebook computer, a desktop computer, a vehicle-mounted terminal, a wearable electronic device, an all-in-one machine, and a smart home device, or may be a device simulated by a virtual machine or a simulator. As shown in FIG. 9, the method may include the following steps.

S3-101: in response to a share operation triggered by a first user for a target task list, access permission of a second user corresponding to the share operation on the target task list is determined.

In this embodiment, when the first user triggers the share operation for the target task list, access permission of a user to share with (the second user) on the target task list is determined. The first user may trigger the share operation in any client interface including the target task list, such as a task center interface, an instant messaging chat interface, a collaborative space interface, and a cloud document interface.

In an embodiment of the present disclosure, determining, in response to the share operation triggered by the first user for the target task list, access permission of the second user corresponding to the share operation on the target task list includes: obtaining a link to the target task list in response to an operation triggered by the first user to copy the link to the target task list; and determining, in response to a share operation triggered by the first user for the link to the target task list, the access permission of the second user corresponding to the share operation on the target task list. That is, the first user may share the target task list by copying the link to the target task list.

The access permission of the second user on the target task list is not higher than that of the first user on the target task list. That is, when the first user shares the target task list, spread access permission cannot exceed the access permission of the first user. For example, when the first user has read permission on the target task list, the second user may have read permission on the target task list; when the first user has edit permission on the target task list, the second user may have read permission or edit permission on the target task list; and when the first user has no access permission on the target task list, the third user also has no access permission on the target task list.

The access permission includes edit permission and read permission. The edit permission means that the user can not only read the target task list, but also edit configuration information of the target task list and edit a task included in the target task list. The editing configuration information corresponding to the target task list may include editing a title of the target task list, a member corresponding to the target task list, and the like. The read permission means that the user can only read and/or comment on the target task list and read and/or comment on the task included in the target task list, but cannot edit the configuration information of the target task list, cannot create or add a task in the target task list, and cannot edit the task included in the target task list. The edit permission includes the read permission.

In some implementations, if the first user has edit permission on the target task list, an edit interface is displayed before the target task list is shared with the second user, where the edit interface is used to edit the access permission of the second user on the target task list. That is, before sharing the target task list with the second user, the first user may edit the access permission of the second user on the target task list.

If the first user has the edit permission on the target task list, after the target task list is shared with the second user, the access permission of the second user on the target task list is changed in response to an edit operation triggered by the first user. That is, after sharing the target task list with the second user, the first user may change the access permission of the second user on the target task list.

That is, when sharing the target task list with the second user, or after sharing, the first user may change the access permission of the second user on the target task list. Therefore, different operation modes are provided for the users, and the convenience in operation is improved.

Specifically, when the first user triggers the share operation for the target task list, the user to share with (the second user) may be selected in a sharing interface, and the access permission of the second user on the target task list may be edited. For ease of understanding, an example in which the first user triggers the share operation in the task center interface is used for description.

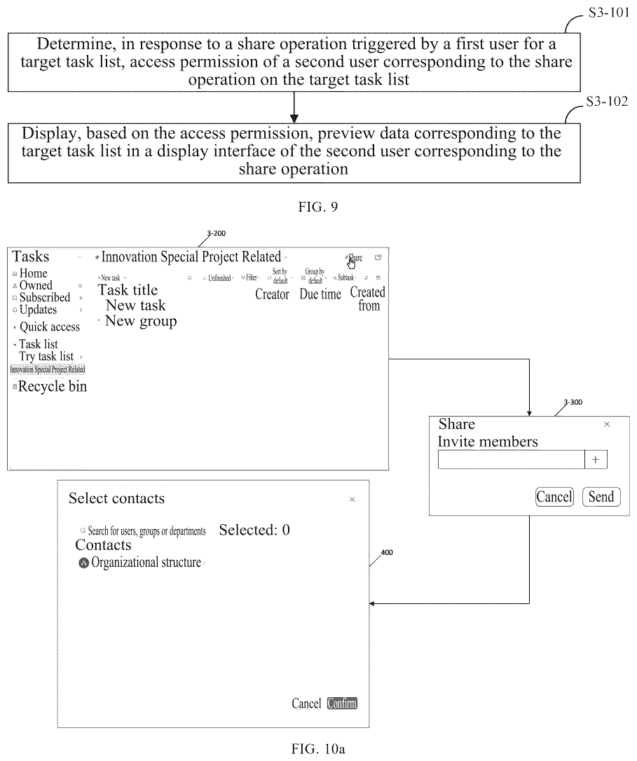

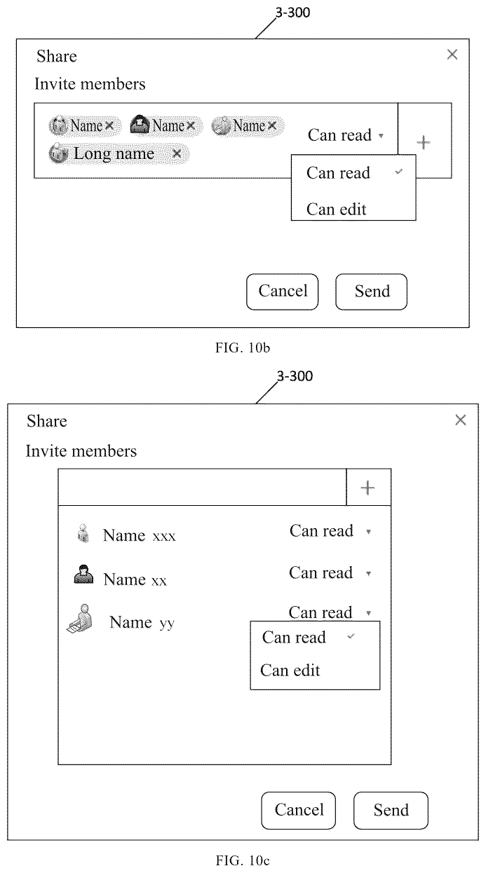

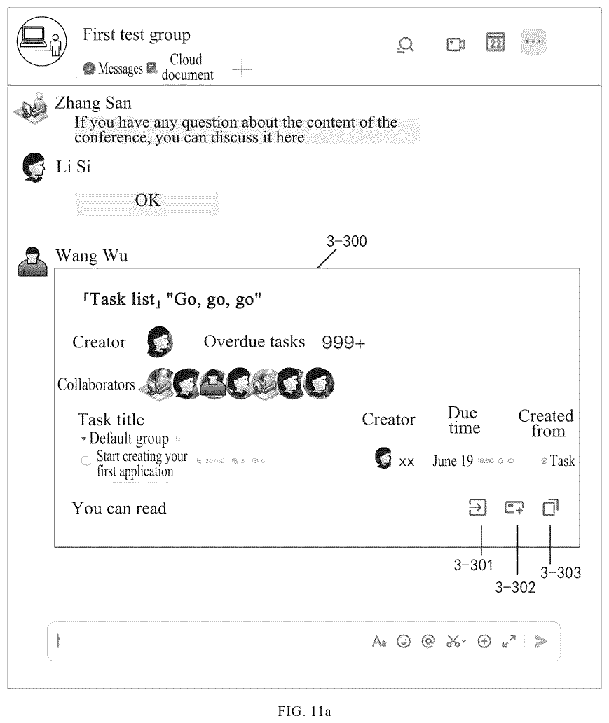

As shown in FIG. 10a, a target task list entitled “Innovation Special Project Related” is displayed in the task center interface, and the first user triggers a share control to display a sharing interface 3-300. In the sharing interface 3-300, the first user may search for information such as a user and a group to share with, or trigger a “+” control to enter a selection interface 3-400, and select a single user or group in an organizational structure through the selection interface 3-400.

After the user determines, through the sharing interface 3-300 or the selection interface 3-400, the user to share with, a user identifier of the selected second user may be displayed in the sharing interface 3-300, where the user identifier may include a user avatar and a user name. For the selected second user, default access permission, such as read permission, on the target task list may be granted to the second user. Alternatively, the access permission of the second user on the target task list is set during the share operation. For example, as shown in FIG. 10b, user identifiers of multiple second users selected are displayed in an invite box, and access permission of the multiple second users on the target task list may be set. In this case, the multiple second users may correspond to the same access permission, which may be specifically read permission or edit permission. Alternatively, as shown in FIG. 10c, user identifiers of multiple second users selected are displayed in separate rows, and the first user may separately set access permission for the multiple second users, so as to set different access permission for different second users.

After access permission corresponding to each second user is set through the above sharing interface 3-300, a send control is triggered to share the target task list to a display interface corresponding to each second user.

After the first user shares the target task list with the second user through the task center interface, the second user can view the target task list in the corresponding task center interface, and/or the second user can view the target task list in an interface of a chat created by the second user and the first user.

S3-102: based on the access permission, preview data corresponding to the target task list is displayed in a display interface of the second user corresponding to the share operation.

After the share operation is completed, the client displays, based on the access permission, the preview data corresponding to the target task list in the display interface of the second user corresponding to the share operation. That is, when the second user has the access permission or does not have the access permission on the target task list, preview data that can be viewed by the second user in the display interface is different.

In a scenario where the first user shares the target task list to a first chat, the display interface of the second user corresponding to the share operation is an interface of the first chat, and the first user and the second user are both members of the first chat. Alternatively, in a scenario where the first user shares the target task list to a first cloud document, the display interface of the second user corresponding to the share operation is a cloud document interface of the first cloud document, and the first user and the second user are both collaborators of the first cloud document. Specifically, when sharing the target task list, the first user may select all or some of members in the first chat to share with, or select all or some of collaborators of the first cloud document to share with, which is not limited in this embodiment.

In this embodiment, a task list is a task container for containing tasks. The task list may include one or more tasks. In some embodiments, the task list may include zero (0) tasks. In some embodiments, a task may be created in the task list, an existing task may also be added to the task list, and each task in the task list may be managed and operated based on the task list. In some embodiments, the task list does not depend on another entity in the client, and may exist independently. For example, the task list does not depend on entities such as a group, a team, a document, a conference, a collaborative space, a department, and a project. The client may be an application for collaborative office, such as an application mainly having an IM function, an application mainly having a task function, or an office suite application that integrates IM, tasks, documents and other functions.

In some implementations, the user may trigger an operation in an interface of a chat to add the target task list as a chat tab. Specifically, the user may add the same task list as chat tabs to multiple chats having no association relationship, or add the same task list as chat tabs to multiple chats having a specific association relationship.

That the multiple chats have no association relationship may mean that there is no subordinate relationship between the multiple chats, and the multiple chats do not belong to the same other entity (such as a group, a team, a workspace, a department, or a project). For example, the first chat and a second chat are not chats within the same team or workspace. Thus, in these embodiments, a task list can be flexibly and freely added to a chat tag of any chat. That the multiple chats have the specific association relationship may mean that the multiple chats belong to the same other entity (such as a group, a team, a workspace, a department, or a project).

This embodiment of the present disclosure provides the task list sharing method and apparatus, a device, and a medium, to quickly share a task list with different users, so that different users can view the task list, which improves the user experience. Thus, when the share operation triggered by the first user for the target task list is received, the access permission of the second user corresponding to the share operation on the target task list is determined. The second user is a user to share with. After the access permission of the second user on the target task list is determined, the preview data corresponding to the target task list is displayed in the display interface of the second user corresponding to the share operation based on the access permission. That is, according to the technical solutions provided by this embodiment of the present disclosure, a task list can be shared. During sharing, access permission of a user to share with on the task list is first determined, and then preview data of the task list is displayed, based on the access permission, in a display interface corresponding to the user to share with, so that different users can view information in the task list, which improves the user experience.

In some implementations, an independent window is displayed in response to a trigger operation of the second user for the target task list in the display interface, and information in the target task list is displayed in the independent window.

If the second user has the access permission on the target task list, the preview data includes at least one or more of a title of the target task list, an owner identifier of the target task list, a collaborator identifier of the target task list, or information about the access permission of the second user. The collaborator of the target task list, that is, a member of the target task list, can read or edit the target task list. If the second user does not have the access permission on the target task list, the preview data includes first prompt information and a first control. The first prompt information is used to prompt for no access permission on the target task list, and the first control is used to request the access permission.

In some implementations, if the second user has the access permission on the target task list and the target task list includes an overdue task, the preview data may include related information of the overdue task, and in some embodiments, the related information of the overdue task may include the number of overdue tasks; and/or the preview data includes related information of at least some tasks in the target task list, and the related information of the at least some tasks may include task titles, creators, due time, the number of subtasks included in a parent task, and the like.

In some implementations, if the second user has the access permission on the target task list, the preview data includes one or more of the following controls: a second control used to open the target task list in the task center interface; a third control used to add, if the display interface corresponding to the second user is a chat interface, the target task list as a chat tag of the chat interface; or a fourth control used to copy the link to the target task list.

Since the link to the target task list may be copied through the fourth control, the share operation triggered by the first user for the target task list may be implemented by triggering the fourth control. Specifically, the link to the target task list is obtained in response to a trigger operation of the first user for the fourth control, and in response to a share operation triggered by the first user for the link to the target task list, the access permission of the second user corresponding to the share operation on the target task list is determined. Specifically, by copying the link to the target task list, the first user may send the link to the target task list to the same chat that the first user and the second user are both in, or paste the link to the target task list into the same cloud document in which the first user and the second user are both collaborators.

When the client displays, based on the access permission, the preview data corresponding to the target task list in the interface of the second user corresponding to the share operation, the preview data may be displayed in the form of a preview card. Specifically, the preview card of the target task list is displayed in the display interface of the second user corresponding to the share operation, and the preview data is carried by the preview card.

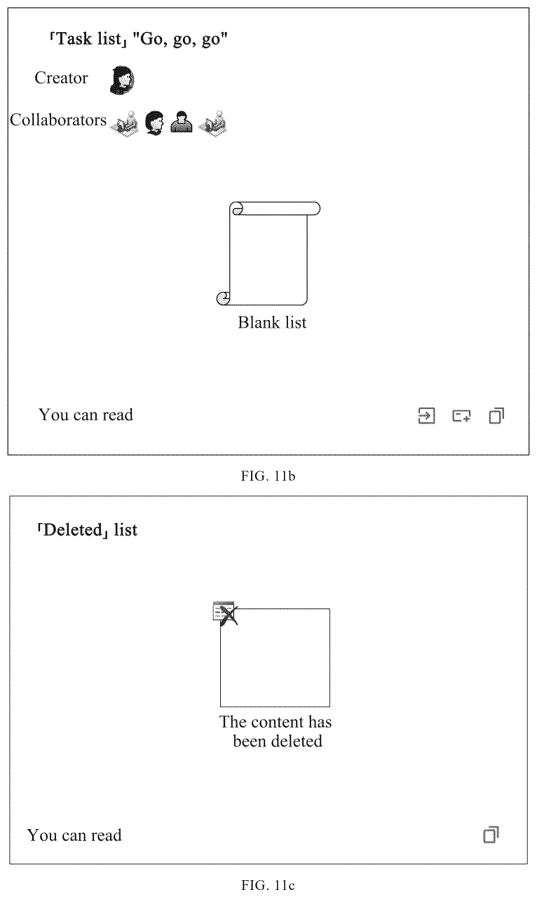

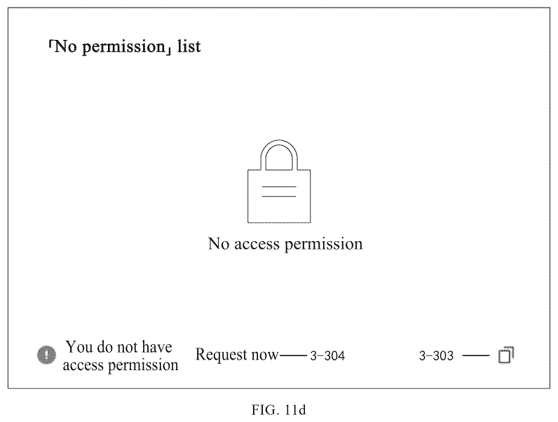

For example, as shown in FIG. 11a, the target task list is shared in a chat interface corresponding to the second user, and the preview data corresponding to the target task list is displayed in a preview card 3-300. Specifically, the preview card includes a title “Go, go, go” of the target task list, a creator, the number of overdue tasks, a collaborator identifier, and related information of some tasks included. Since the second user has read permission on the target task list, a second control 3-301, a third control 3-302, and a fourth control 3-303 may be displayed in the preview card 3-300.

In some implementations, if the target task list is a blank task list (a task list that does not include a task), a display style of the preview card is as shown in FIG. 11b, including a title “Go, go, go” of the target task list, a creator, a collaborator identifier, and a blank document icon. Since the second user has read permission on the target task list, the second control, the third control, and the fourth control may be displayed in the preview card.

In some implementations, second prompt information may be displayed in the preview card if the target task list is deleted, where the second prompt information is used to prompt that the target task list has been deleted. After the target task list is deleted, a display style of the preview card is as shown in FIG. 11c, and the read permission of the second user and the fourth control may still be displayed.

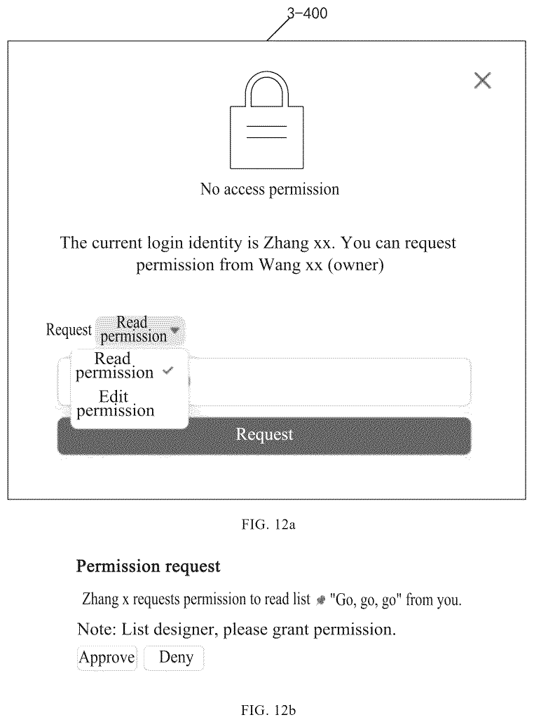

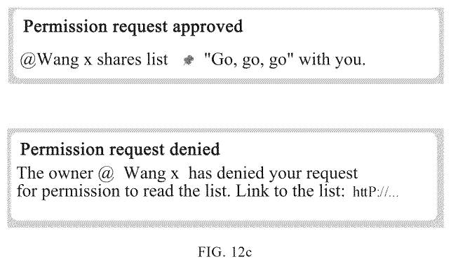

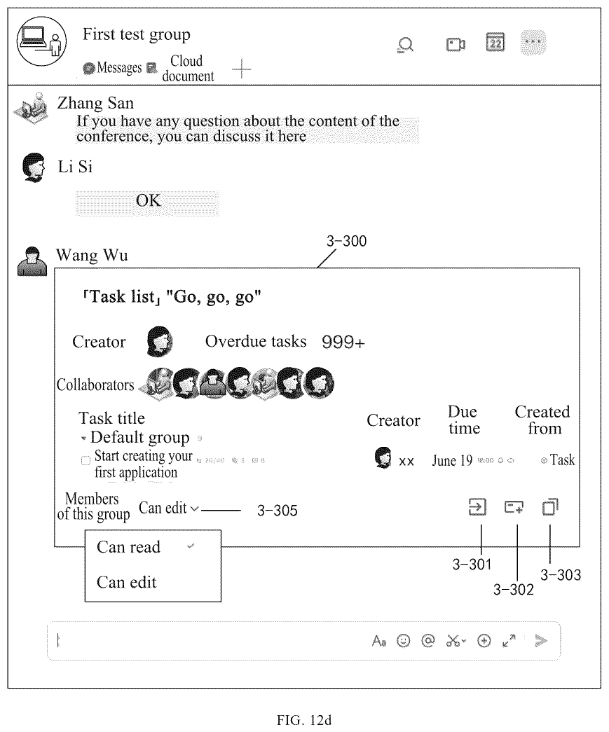

If the second user does not have the access permission on the target task list, a display style of the preview card is as shown in FIG. 11d, and first prompt information “You do not have access permission”, the first control 3-304, and the fourth control 3-303 are displayed. It is possible to request the access permission from an owner of the target task list through the first control 3-304. When the user triggers the first control 3-304, a permission request interface may be displayed, as shown in FIG. 12a. In a permission request interface 3-400, the user may request read permission or edit permission, and may further enter note information in an input box displayed in the interface 3-400.

After the user sends a permission request to the owner of the target task list, the client may send a notification message to the owner to inform the owner that the user requests the access permission on the target task list. For example, as shown in FIG. 12b, the notification message may be automatically sent through a task assistant, and a user identifier of the requester, the title of the target task list, the note information, an approve control, and a deny control may be displayed in the notification message. No matter which control the owner triggers, the notification message is sent to the requester to inform a request result. When the owner triggers the approve control, the notification message sent to the requester is as shown in the upper figure in FIG. 12c; or when the owner triggers the deny control, the notification message sent to the requester is as shown in the lower figure in FIG. 12c.

In some implementations, if the first user views the preview card of the task list, the preview card of the target task list is displayed in an interface of the first user corresponding to the share operation, and the preview card includes a fifth control used to change the access permission of the second user on the target task list. For example, as shown in FIG. 12d, when a user who shares the target task list views the preview card of the target task list through the chat interface, a fifth control 3-305 may be displayed for changing access permission of a member in a chat on the target task list through the fifth control 3-305.

In this embodiment, the second user may further trigger the fourth control displayed in the preview card of the target task list, to obtain the link to the target task list, and then share the target task list again, so that more users can view the related information of the target task list.

Based on the above method embodiment, an embodiment of the present disclosure further provides a task list sharing apparatus and an electronic device, which will be described below with reference to the accompanying drawings.

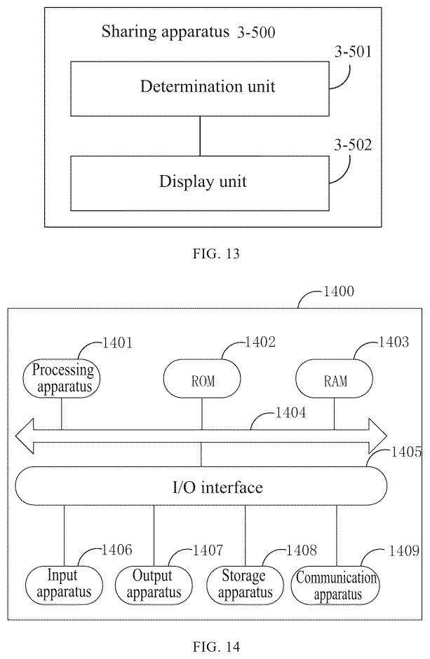

Reference is made to FIG. 13, which is a schematic diagram of a structure of a task list sharing apparatus according to an embodiment of the present disclosure. As shown in FIG. 13, the apparatus 3-500 may include a determination unit 3-501 and a display unit 3-502.

The determination unit 3-501 is configured to determine, in response to a share operation triggered by a first user for a target task list, access permission of a second user corresponding to the share operation on the target task list.

The display unit 3-502 is configured to display, based on the access permission, preview data corresponding to the target task list in a display interface of the second user corresponding to the share operation.

In some implementations, the display unit 3-502 is further configured to display an independent window in response to a trigger operation of the second user for the target task list in the display interface, and display, in the independent window, information in the target task list.

In some implementations, if the second user has the access permission on the target task list, the preview data includes at least one or more of a title of the target task list, an owner identifier of the target task list, a collaborator identifier of the target task list, or information about the access permission of the second user. Alternatively, if the second user does not have the access permission on the target task list, the preview data includes first prompt information and a first control, where the first prompt information is used to prompt for no access permission on the target task list, and the first control is used to request the access permission.

In some implementations, the access permission includes edit permission or read permission.

In some implementations, if the second user has the access permission on the target task list and the target task list includes an overdue task, the preview data includes related information of the overdue task. Alternatively, the preview data includes related information of at least some tasks in the target task list.

In some implementations, if the second user has the access permission on the target task list, the preview data includes one or more of the following controls:
a second control used to open the target task list in a task center interface;
a third control used to add, if the display interface corresponding to the second user is a chat interface, the target task list as a chat tag of the chat interface; or
a fourth control used to copy a link to the target task list.

In some implementations, the determination unit 3-501 is specifically configured to: obtain a link to the target task list in response to an operation triggered by the first user to copy the link to the target task list; and determine, in response to a share operation triggered by the first user for the link to the target task list, the access permission of the second user corresponding to the share operation on the target task list.

In some implementations, the access permission of the second user on the target task list is not higher than that of the first user on the target task list.

In some implementations, the apparatus further includes a change unit.

The display unit 3-501 is further configured to: if the first user has edit permission on the target task list, display an edit interface before the target task list is shared with the second user, the edit interface being used to edit the access permission of the second user on the target task list.

The change unit is configured to: if the first user has the edit permission on the target task list, after the target task list is shared with the second user, change the access permission of the second user on the target task list in response to an edit operation triggered by the first user.

In some implementations, the display unit 3-502 is specifically configured to display a preview card of the target task list in the display interface of the second user corresponding to the share operation.

In some implementations, the display unit 3-502 is further configured to display the preview card of the target task list in an interface of the first user corresponding to the share operation, where the preview card includes a fifth control used to change the access permission of the second user on the target task list.

In some implementations, the display unit 3-502 is further configured to display second prompt information in the preview card if the target task list is deleted, where the second prompt information is used to prompt that the target task list has been deleted.

In some implementations, the display interface of the second user corresponding to the share operation is a chat interface of a first chat, and the first user and the second user are both members of the first chat. Alternatively, the display interface of the second user corresponding to the share operation is a cloud document interface of a first cloud document, and the first user and the second user are both collaborators of the first cloud document.

It should be noted that, for a specific implementation of the various units in this embodiment, reference may be made to the related description in the above method embodiment. The division into the units in this embodiment of the present disclosure is illustrative and is merely logical function division, and there may be other division methods in actual implementation. Various function units in this embodiment of the present disclosure may be integrated into one processing unit, each of the units may exist alone physically, or two or more units may be integrated into one unit. For example, in the above embodiment, a processing unit and a sending unit may be the same unit or different units. The integrated unit may be implemented in the form of hardware, or may be implemented in the form of a software function unit.

Reference is made to FIG. 14, which is a schematic diagram of a structure of an electronic device 1400 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 14 is merely an example, and shall not impose any limitation on the function and scope of use of the embodiments of the present disclosure.

As shown in FIG. 14, the electronic device 1400 may include a processing apparatus (e.g., a central processing unit or a graphics processing unit) 1401 that may perform a variety of appropriate actions and processing in accordance with a program stored in a read-only memory (ROM) 1402 or a program loaded from a storage apparatus 1408 into a random access memory (RAM) 1403. The RAM 1403 further stores various programs and data required for operations of the electronic device 1400. The processing apparatus 1401, the ROM 1402, and the RAM 1403 are connected to each other through a bus 1404. An input/output (I/O) interface 1405 is also connected to the bus 1404.

Generally, the following apparatuses may be connected to the I/O interface 1405: an input apparatus 1406 including, for example, a touchscreen, a touchpad, a keyboard, a mouse, a camera, a microphone, an accelerometer, and a gyroscope; an output apparatus 1407 including, for example, a liquid crystal display (LCD), a speaker, and a vibrator; the storage apparatus 1408 including, for example, a tape and a hard disk; and a communication apparatus 1409. The communication apparatus 1409 may allow the electronic device 1400 to perform wireless or wired communication with other devices to exchange data. Although FIG. 14 shows the electronic device 1400 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 1409, installed from the storage apparatus 1408, or installed from the ROM 1402. When the computer program is executed by the processing apparatus 1401, the above-mentioned functions defined in the method of the embodiment of the present disclosure are performed.

The electronic device according to this embodiment of the present disclosure and the method according to the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium storing a computer program thereon, where the program, when executed by a processor, implements the method according to the above embodiments.

It should be noted that the above computer-readable medium described in the present disclosure may be a computer-readable signal medium, a computer-readable storage medium, or any combination thereof. The computer-readable storage medium may be, for example but not limited to, an electric, magnetic, optical, electromagnetic, infrared, or semiconductor system, apparatus, or device, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the above method.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a first user, partially executed on a computer of a first user, executed as an independent software package, partially executed on a computer of a first user and partially executed on a remote computer, or completely executed on a remote computer or server. In the case of the remote computer, the remote computer may be connected to the computer of the first user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from those marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of the unit/module does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

It should be noted that the various embodiments in this specification are described in a progressive manner, and each embodiment focuses on the differences from other embodiments. The same or similar parts between the various embodiments may be referenced to each other. For the system or apparatus disclosed in the embodiments, since it corresponds to the method disclosed in the embodiments, the description is simple, and for the related parts, reference may be made to the description of the method.

It should be understood that, in some embodiments of the present disclosure, “at least one” means one or more, and “a plurality of” means two or more. The term “and/or” is used to describe an association relationship between associated objects, and indicates that three relationships may exist, for example, A and/or B may indicate that: only A exists, only B exists, and both A and B exist, where A or B may be singular or plural. The character “/” generally indicates an “or” relationship between the associated objects. “At least one of the following” or similar expressions refers to any combination of these items, including any combination of single items or plural items. For example, at least one of a, b, or c may indicate: a, b, and c, “a and b”, “a and c”, “b and c”, or “a and b and c”, where a, b, or c may be singular or plural.

It should also be noted that, herein, relative terms such as “first” and “second” are only used to distinguish one entity or operation from another entity or operation, and do not necessarily require or imply that such an actual relationship or order exists between these entities or operations. Moreover, the terms “include” and “comprise”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including a . . . ” does not exclude another identical element in a process, method, article, or device that includes the element.

The steps of the method or algorithm described with reference to the embodiments disclosed herein may be implemented directly in hardware, in a software module executed by a processor, or in a combination of the two. The software module may be disposed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

With respect to the above description of the disclosed embodiments, those skilled in the art could implement or use the present disclosure. Various modifications to these embodiments are apparent to those skilled in the art, and the general principle defined herein may be practiced in other embodiments without departing from the spirit or scope of the present disclosure. Therefore, the present disclosure will not be limited to the embodiments shown herein, but extends to the widest scope that complies with the principles and novelty disclosed in this specification.

Further aspects of the present disclosure are set forth in the following numbered clauses.

1. A task list creation method, including:
receiving a task list creation operation triggered by a first user in a first client interface, to obtain task list related information entered by the first user; and
generating a first task list based on the task list related information, where the first task list is a task container, and the first task list does not depend on another entity in an application to which the first client interface belongs.

2. The method according to clause 1, where the first client interface is a task center interface, an instant messaging chat interface, a collaborative space interface, or a cloud document interface.

3. The method according to clause 1, where the first user is an owner of the first task list, and the owner of the first task list has edit permission on the first task list.

4. The method according to clause 3, further including:
transferring ownership of the first task list to a second user in response to a transfer operation triggered by the first user for the first task list, to make the second user the owner of the first task list.

5. The method according to clause 3, where the edit permission includes one or more of:
editing configuration information corresponding to the first task list, where the editing configuration information corresponding to the first task list includes archiving the first task list and/or deleting the first task list; or
editing a task included in the first task list.

6. The method according to clause 1, where the first task list has one or more members, and the members each have edit permission or read permission on the first task list.

7. The method according to clause 6, where the member of the first task list is added in one or more of the following ways:
the task list related information includes member information, and when the first task list is generated based on the task list related information, the member is added to the first task list based on the member information;
after the first task list is generated, the member is added to the first task list in response to a member adding operation triggered for the first task list;
if the first task list is created in an instant messaging chat interface, all or some of chat members of the instant messaging chat are determined as members of the first task list; or
if the first task list is created in a cloud document interface, all or some of collaborators of the cloud document interface are determined as members of the first task list.

8. The method according to clause 6, where the edit permission includes one or more of the following:
editing configuration information corresponding to the first task list, where the editing configuration information corresponding to the first task list does not include archiving the first task list or deleting the first task list; or
editing a task included in the first task list.

9. The method according to clause 6, where the read permission includes one or more of:
reading and/or commenting on the first task list, without permission to edit configuration information corresponding to the first task list; or
reading and/or commenting on a task included in the first task list, without permission to create or add a task in the first task list and without permission to edit the task included in the first task list.

10. The method according to clause 1, further including:
configuring, in response to creating or adding a target task in the first task list, permission on the target task for a member of the first task list based on permission of the member of the first task list on the first task list.

11. The method according to clause 10, where
if a member of the first task list has edit permission on the first task list, the member has edit permission on the target task; and
if a member of the first task list has read permission on the first task list, the member has at least read permission on the target task.

12. The method according to clause 1, further including one or more of the following:
stopping displaying, in response to a task in the first task list being deleted, the deleted task in the first task list;
skipping performing, in response to the first task list being deleted, a delete operation on a task in the first task list; or
deleting, in response to the first task list being deleted, a task without a person-in-charge in the first task list.

13. The method according to clause 1, further including:
if the first task list is created or added in a first service interface, granting first permission on the first task list to an associated member of the first service interface by default, and changing permission of the associated member on the first task list to second permission in response to an edit operation triggered for the first task list; or
if the first task list is created or added in a first service interface, granting permission on the first task list to an associated member of the first service interface based on a permission configuration operation.

14. The method according to clause 13, where
the first service interface includes an instant messaging chat interface or a cloud document interface;
when the first service interface is the instant messaging chat interface, the associated member of the first service interface is some or all of corresponding chat members; and
when the first service interface is the cloud document chat interface, the associated member of the first service interface is some or all of corresponding cloud document collaborators.

15. The method according to clause 13, further including one or more of:
if permission of one or more associated members on the first task list is changed to no permission, displaying first prompt information in the first service interface corresponding to the one or more associated members, the first prompt information being used to prompt for no permission to access the first task list; or
displaying second prompt information in the first service interface if the first task list is deleted, the second prompt information being used to prompt that the first task list has been deleted.

16. The method according to clause 1, further including:
in response to a third user sharing the first task list with a fourth user, granting permission on the first task list to the fourth user, the permission of the fourth user on the first task list being not higher than that of the third user on the first task list.

17. The method according to clause 1, where if the first task list includes a first member and a first task, permission of the first member on the first task is target permission, and the target permission is a higher on of permission corresponding to a role that the first member takes in the first task and permission on the first task list granted to the first member.

18. A task list creation apparatus, including:
a receiving unit configured to receive a task list creation operation triggered by a first user in a first client interface, to obtain task list related information entered by the first user; and
a generation unit configured to generate a first task list based on the task list related information, where the first task list is a task container, and the first task list does not depend on another entity in an application to which the first client interface belongs.

19. An electronic device, including a processor and a memory, where
the memory is configured to store instructions or a computer program; and
the processor is configured to execute the instructions or the computer program in the memory, to cause the electronic device to perform the method according to any of clauses 1 to 17.

20. A computer-readable storage medium having instructions stored therein, where the instructions, when run on a device, cause the device to perform the method according to any of clauses 1 to 17.

21. An information exchange method, including:
adding, in response to an operation triggered in an interface of a first chat to add a first task list as a chat tab, a first chat tab corresponding to the first task list to the interface of the first chat, where the first task list has been added as a chat tab of a second chat, the chat tab corresponding to the first task list in an interface of the second chat is a second chat tab, and the first chat and the second chat have a first association relationship or have no association relationship; and
displaying the first task list in response to a trigger operation for the first chat tab in the interface of the first chat.

22. The method according to clause 21, further including:
granting first permission on the first task list to all or some of members in the first chat in response to adding the first chat tab corresponding to the first task list to the interface of the first chat.

23. The method according to clause 22, further including one or more of:
providing a permission editing control before granting the first permission on the first task list to the member in the first chat, to grant the first permission on the first task list to all or some of the members in the first chat based on an operation of a user for the permission editing control; or
after the first chat tab corresponding to the first task list is added to the interface of the first chat, changing permission of all or some of the members in the first chat on the first task list to second permission in response to an edit operation triggered for the first chat tab.

24. The method according to clause 21, where the interface of the first chat includes a chat message display area and a non-chat message display area, the first chat tab is displayed in a first display area of the non-chat message display area, and a second display area of the non-chat message display area is used to display basic information and/or a basic function control of the first chat.

25. The method according to clause 21, where adding, in response to the operation triggered in the interface of the first chat to add a first task list as the chat tab, the first chat tab corresponding to the first task list to the interface of the first chat includes:
if the first task list does not exist before the first chat tab corresponding to the first task list is added to the interface of the first chat, displaying a first interface in response to a trigger operation for a first add control in the interface of the first chat, the first interface being used to add a chat tab corresponding to a task list, creating the first task list in response to a task list creation operation triggered in the first interface, and adding the first chat tab corresponding to the first task list to the interface of the first chat; or
if the first task list already exists before the first task list tag is added to the interface of the first chat, displaying a first interface in response to a trigger operation for a first add control in the interface of the first chat, the first interface being used to add a chat tab corresponding to a task list, and in response to an operation triggered in the first interface to add the existing first task list, adding the first chat tab corresponding to the first task list to the interface of the first chat.

26. The method according to clause 25, where displaying the first interface in response to the trigger operation for the first add control in the interface of the first chat includes:
displaying a first window in response to a trigger operation for a first control in the interface of the first chat, the first window including a tab adding control;
displaying a second window in response to a trigger operation for the tab adding control, the second window including a task list tab adding control; and
displaying the first interface in response to a trigger operation for the task list tab adding control.

27. The method according to clause 21, where displaying the first task list in response to the trigger operation for the first chat tab in the interface of the first chat includes:
displaying the first task list in the interface of the first chat in response to the trigger operation for the first chat tab in the interface of the first chat; or
displaying the first task list in a third window in response to a trigger operation for the first chat tab in the interface of the first chat, the third window being independent of the interface of the first chat.

28. The method according to clause 21, further including:
displaying a fourth window in response to triggering a preset operation for the first chat tab in the interface of the first chat,
where the fourth window including one or more of the following controls:
   an open control used to open the task list in a task center;
   a copy control used to copy a link to the first task list;
   an edit control used to edit a tag name of the first chat tab; or
   a delete control used to remove the first chat tab from the interface of the first chat.

29. The method according to clause 21, where
a display style of the first chat tab includes a preset identifier corresponding to a task type.

30. The method according to clause 21, further including:
retaining access permission of all or some of the members in the first chat on the first task list if the first chat tab is removed from the interface of the first chat; or
removing access permission of all or some of the members in the first chat on the first task list if the first chat tab is removed from the interface of the first chat; or
if all or some of the members in the first chat have edit permission on the first task list, granting read permission on the first task list to all or some of the members in the first chat after the first chat tab is removed from the interface of the first chat.

31. An information exchange apparatus, including:
an addition unit configured to add, in response to an operation triggered in an interface of a first chat to add a first task list as a chat tab, a first chat tab corresponding to the first task list to the interface of the first chat, where the first task list has been added as a chat tab of a second chat, the chat tab corresponding to the first task list in an interface of the second chat is a second chat tab, and the first chat and the second chat have a first association relationship or have no association relationship; and
a display unit configured to display the first task list in response to a trigger operation for the first chat tab in the interface of the first chat.

32. An electronic device, including a processor and a memory, where
the memory is configured to store instructions or a computer program; and
the processor is configured to execute the instructions or the computer program in the memory, to cause the electronic device to perform the method according to any of clauses 21 to 30.

33. A computer-readable storage medium having instructions stored therein, where the instructions, when run on a device, cause the device to perform the method according to any of clauses 21 to 30.

34. A task list sharing method, including:
determining, in response to a share operation triggered by a first user for a target task list, access permission of a second user corresponding to the share operation on the target task list; and
displaying, based on the access permission, preview data corresponding to the target task list in a display interface of the second user corresponding to the share operation.

35. The method according to clause 34, further including:
displaying an independent window in response to a trigger operation of the second user for the target task list in the display interface, and displaying, in the independent window, information in the target task list.

36. The method according to clause 34, where
if the second user has the access permission on the target task list, the preview data includes at least one or more of a title of the target task list, an owner identifier of the target task list, a collaborator identifier of the target task list, or information about the access permission of the second user; or
if the second user does not have the access permission on the target task list, the preview data includes first prompt information and a first control, the first prompt information is used to prompt for no access permission on the target task list, and the first control is used to request the access permission.

37. The method according to clause 34, where the access permission includes edit permission or read permission.

38. The method according to clause 34, where
if the second user has the access permission on the target task list and the target task list includes an overdue task, the preview data includes related information of the overdue task; and/or
the preview data includes related information of at least some tasks in the target task list.

39. The method according to clause 34, where if the second user has the access permission on the target task list, the preview data includes one or more of the following controls:
a second control used to open the target task list in a task center interface;
a third control used to add, if the display interface corresponding to the second user is a chat interface, the target task list as a chat tag of the chat interface; or
a fourth control used to copy a link to the target task list.

40. The method according to clause 34, where the determining, in response to a share operation triggered by a first user for a target task list, access permission of a second user corresponding to the share operation on the target task list includes:
obtaining a link to the target task list in response to an operation triggered by the first user to copy the link to the target task list; and
determining, in response to a share operation triggered by the first user for the link to the target task list, the access permission of the second user corresponding to the share operation on the target task list.

41. The method according to clause 34, where the access permission of the second user on the target task list is not higher than that of the first user on the target task list.

42. The method according to clause 34, further including one or more of:
if the first user has edit permission on the target task list, displaying an edit interface before the target task list is shared with the second user, the edit interface being used to edit the access permission of the second user on the target task list; or
if the first user has the edit permission on the target task list, after the target task list is shared with the second user, changing the access permission of the second user on the target task list in response to an edit operation triggered by the first user.

43. The method according to any one of clauses 34 to 42, where displaying, based on the access permission, the preview data corresponding to the target task list in the display interface of the second user corresponding to the share operation includes:
displaying a preview card of the target task list in the display interface of the second user corresponding to the share operation.

44. The method according to clause 43, further including:
displaying the preview card of the target task list in an interface of the first user corresponding to the share operation, the preview card including a fifth control used to change the access permission of the second user on the target task list.

45. The method according to clause 43, further including:
displaying second prompt information in the preview card if the target task list is deleted, the second prompt information being used to prompt that the target task list has been deleted.

46. The method according to clause 34, where the display interface of the second user corresponding to the share operation is a chat interface of a first chat, and the first user and the second user are both members of the first chat; or
the display interface of the second user corresponding to the share operation is a cloud document interface of a first cloud document, and the first user and the second user are both collaborators of the first cloud document.

47. A task list sharing apparatus, including:
a determination unit configured to determine, in response to a share operation triggered by a first user for a target task list, access permission of a second user corresponding to the share operation on the target task list; and
a display unit configured to display, based on the access permission, preview data corresponding to the target task list in a display interface of the second user corresponding to the share operation.

48. An electronic device, including a processor and a memory, where
the memory is configured to store instructions or a computer program; and
the processor is configured to execute the instructions or the computer program in the memory, to cause the electronic device to perform the method according to any of clauses 34 to 46.

49. A computer-readable storage medium having instructions stored therein, where the instructions, when run on a device, cause the device to execute the method according to any of clauses 34 to 46.

1. A task list creation method, comprising:
receiving a task list creation operation triggered by a first user in a first client interface, to obtain task list related information entered by the first user; and
generating a first task list based on the task list related information, wherein the first task list is a task container, and the first task list does not depend on another entity in an application to which the first client interface belongs.

2. The method according to claim 1, wherein the first client interface is a task center interface, an instant messaging chat interface, a collaborative space interface, or a cloud document interface.

3. The method according to claim 1, wherein the first user is an owner of the first task list, and the owner of the first task list has edit permission on the first task list.

4. The method according to claim 3, further comprising:
transferring ownership of the first task list to a second user in response to a transfer operation triggered by the first user for the first task list, to make the second user the owner of the first task list.

5. The method according to claim 3, wherein the edit permission comprises one or more of:
editing configuration information corresponding to the first task list, wherein the editing configuration information corresponding to the first task list comprises archiving the first task list and/or deleting the first task list; or
editing a task comprised in the first task list.

6. The method according to claim 1, wherein the first task list has one or more members, and the members each have edit permission or read permission on the first task list.

7. The method according to claim 6, wherein the members of the first task list is added in one or more of the following ways:
the task list related information comprises member information, and when the first task list is generated based on the task list related information, a member is added to the first task list based on the member information;
after the first task list is generated, the member is added to the first task list in response to a member adding operation triggered for the first task list;
in response to the first task list being created in an instant messaging chat interface, all or some of chat members of the instant messaging chat are determined as members of the first task list; or
in response to the first task list being created in a cloud document interface, all or some of collaborators of the cloud document interface are determined as members of the first task list.

8. The method according to claim 6, wherein the edit permission comprises one or more of:
editing configuration information corresponding to the first task list, wherein the editing configuration information corresponding to the first task list does not comprise archiving the first task list or deleting the first task list; or
editing a task comprised in the first task list.

9. The method according to claim 6, wherein the read permission comprises one or more of:
reading and/or commenting on the first task list, without permission to edit configuration information corresponding to the first task list; or
reading and/or commenting on a task comprised in the first task list, without permission to create or add a task in the first task list and without permission to edit a task comprised in the first task list.

10. The method according to claim 1, further comprising:
configuring, in response to creating or adding a target task in the first task list, permission on the target task for a member of the first task list based on permission of the member of the first task list on the first task list.

11. The method according to claim 10, wherein
in response to a member of the first task list having edit permission on the first task list, the member has edit permission on the target task; and
in response to a member of the first task list having read permission on the first task list, the member has at least read permission on the target task.

12. The method according to claim 1, further comprising one or more of:
stopping displaying, in response to a task in the first task list being deleted, the deleted task in the first task list;
skipping, in response to the first task list being deleted, performing a delete operation on a task in the first task list; or
deleting, in response to the first task list being deleted, a task without a person-in-charge in the first task list.

13. The method according to claim 1, further comprising:
in response to the first task list being created or added in a first service interface, granting first permission on the first task list to an associated member of the first service interface by default, and changing permission of the associated member on the first task list to second permission in response to an edit operation triggered for the first task list; or
in response to the first task list being created or added in a first service interface, granting permission on the first task list to an associated member of the first service interface based on a permission configuration operation.

14. The method according to claim 13, wherein
the first service interface comprises an instant messaging chat interface or a cloud document interface;
in response to the first service interface being the instant messaging chat interface, the associated member of the first service interface is some or all of corresponding chat members; and
in response to the first service interface being the cloud document chat interface, the associated member of the first service interface is some or all of corresponding cloud document collaborators.

15. The method according to claim 13, further comprising one or more of:
in response to permission of one or more associated members on the first task list changed to no permission, displaying first prompt information in the first service interface corresponding to the one or more associated members, the first prompt information being used to prompt for no permission to access the first task list; or
in response to the first task being deleted, displaying second prompt information in the first service interface, the second prompt information being used to prompt that the first task list has been deleted.

16. The method according to claim 1, further comprising:
in response to a third user sharing the first task list with a fourth user, granting permission on the first task list to the fourth user, the permission of the fourth user on the first task list being not higher than that of the third user on the first task list.

17. The method according to claim 1, wherein in response to the first task list comprising a first member and a first task, permission of the first member on the first task is target permission, and the target permission is a higher one of permission corresponding to a role that the first member takes in the first task and permission on the first task list granted to the first member.

18. (canceled)

19. An electronic device, comprising a processor and a memory, wherein
the memory is configured to store instructions or a computer program; and
the processor is configured to execute the instructions or the computer program in the memory, to cause the electronic device to:
receive a task list creation operation triggered by a first user in a first client interface, to obtain task list related information entered by the first user; and
generate a first task list based on the task list related information, wherein the first task list is a task container, and the first task list does not depend on another entity in an application to which the first client interface belongs.

20. A non-transitory computer-readable storage medium having instructions stored therein, wherein the instructions, when run on a device, cause the device to:
receive a task list creation operation triggered by a first user in a first client interface, to obtain task list related information entered by the first user; and
generate a first task list based on the task list related information, wherein the first task list is a task container, and the first task list does not depend on another entity in an application to which the first client interface belongs.

21-49. (canceled)

50. The electronic device according to claim 19, wherein the first client interface is a task center interface, an instant messaging chat interface, a collaborative space interface, or a cloud document interface.
